(19) United States
(12) Patent Application Publication
(10) Pub. No.: US 2026/0004270 A1
(43) Pub. Date: Jan. 1, 2026

(54) SYSTEMS AND METHODS FOR PROVIDING AUTOMATIC ISSUE RESOLUTION

(71) Applicant: Wells Fargo Bank, N.A., San Francisco, CA (US)

(72) Inventors: Chelsea K. McDermott-Leoncio, American Canyon, CA (US); Robin H. Lo, San Francisco, CA (US); Young M. Yang, San Francisco, CA (US); Tiffany Twilley, Foster City, CA (US); Caroline Machado, Mountain View, CA (US)

(21) Appl. No.: 18/758,253

(22) Filed: Jun. 28, 2024

(51) Int. Cl. G06Q 20/20; G06Q 20/36

(52) U.S. Cl. CPC G06Q 20/206; G06Q 20/36

(57) ABSTRACT

Systems, apparatuses, methods, and computer program products are disclosed for providing automatic issue resolution at a point-of-sale (POS). An example method includes receiving a transaction attempt at a POS, where the transaction attempt is associated with a payment account of a user. The example method further includes determining whether the transaction attempt should be declined, where determining whether the transaction attempt should be declined comprises determining at least a first transaction declination reason associated with the transaction attempt and determining whether the transaction declination reason is comprised in a transaction declination exception set associated with the payment account. The example method further includes, in response to determining that the first transaction declination reason is comprised in the transaction declination exception set, authenticating the user based on a mobile driver's license associated with the user and, in response to successfully authenticating the user based on the mDL, allowing the transaction attempt.

### BACKGROUND

Conventional payment systems may allow access to payment accounts and/or funds via mobile computing devices. However, conventional payment systems and techniques exhibit numerous drawbacks, inefficiencies, and limitations.

### BRIEF SUMMARY

Users may encounter issues at a point-of-sale (POS) (e.g., at a physical merchant location, or remotely via a mobile device) when attempting to make a transaction for various reasons. For example, an enterprise (e.g., a financial institution) may decline a transaction if there is suspected fraud, a user account associated with a corresponding payment card is closed, a payment card is reported stolen, a payment card status is invalid, and/or the like. While these security measures are important for maintaining user account security, some of these transactions may be valid attempts made by the appropriate user. For example, a user may forget to close a lost or stolen payment card report, the user may have prematurely closed a payment card, or the fraud analysis executed by the enterprise may have incorrectly categorized the transaction attempt as fraudulent. In these scenarios, it may be beneficial to perform additional authentication operations by leveraging a user's smart mobile wallet configured with a mobile driver's license (mDL) to confirm the identity of the user and allow the transaction to proceed rather than automatically declining a transaction attempt.

In this regard, enterprises have not had an efficient, effective way to enable users to override transactions declinations that may occur at a POS. Furthermore, the conventional methods for resolving issues at a POS are limited and may result in high costs, wasted technological resources due to computational complexity, and insecure means of ensuring the safe access to funds. For example, various enterprises (e.g., financial institutions) utilizing conventional payment systems may be configured to notify a user (e.g., via email) that a suspected fraudulent transaction has occurred. However, such notifications often occur after a transaction attempt has been executed or declined such that the user is not able to resolve the issue at the POS. Furthermore, resolving various issues based on notifications received from the enterprise (e.g., email notifications) requires that a user gain access to their account (e.g., log in to a web-based user account associated with a respective enterprise, an email account, and/or the like) any time the user wishes to manage and/or resolve a particular issue that has occurred regarding a transaction attempt. It is therefore computationally complex and time-intensive to resolve transaction denial issues using conventional payment systems.

This becomes especially apparent in the event that a transaction attempt is denied at a POS (e.g., a POS terminal at a merchant location). For instance, if a transaction attempt is denied at the POS terminal, the user may have to gain access to their payment account and/or enterprise account, manually authorize an override for the transaction attempt, and then re-attempt the transaction at the POS in order to complete the transaction. This leads to excess computational resource consumption on the part of the user's mobile device and network provider, as well as for the enterprise that manages the payment account and/or user account associated with the user, and even for the merchant associated with the POS terminal, as the merchant may be required to facilitate multiple transaction attempts on behalf of the user.

Various enterprises may also offer conventional smart mobile wallets (e.g., digital wallets) that allow a user to access and/or utilize one or more payment methods via a user device (e.g., a smartphone) to execute payment transactions. However, while a smart mobile wallet conveniently allows a user to securely carry multiple forms of payment (e.g., multiple credit cards, bank cards) and may provide a wide range of advantages over traditional payment methods (e.g., physical currency, paper checks), a conventional smart mobile wallet lacks the ability to facilitate the management (e.g., the override, acceptance, rejection, and/or acknowledgement) of various transaction declinations associated with a respective payment account. Thus, technical challenges arise for users who wish to efficiently manage various transaction declinations that have occurred with one or more payment accounts.

Therefore, it may be beneficial to provide a user with an opportunity to authenticate themselves using at a POS (e.g., a POS terminal) during a particular transaction. In particular, if an enterprise payment system plans to decline a transaction attempt as a potentially fraudulent transaction, it may be desirable to enable the payment system to provide the user with the opportunity to provide an indication of his/her identity at the POS (e.g., the POS terminal). If the payment system can confirm that the user is associated with the transaction, it may approve a transaction attempt that would have otherwise been mistakenly declined. As such, in contrast to conventional payment systems, example embodiments described herein enable a user to efficiently and securely override a transaction declination associated with a payment account without requiring the user or an enterprise representative to access an account (e.g., a payment account and/or user account) to manually override the transaction declination. For example, example embodiments described herein may be configured to leverage an mDL associated with the user in order to facilitate one or more user authentication operations associated with managing a transaction declination associated with a payment account of the user. Furthermore, example embodiments described herein may enable a user to link (e.g., connect, integrate, associate) the payment account to a smart mobile wallet on a user device associated with the user.

In contrast to conventional payment systems and techniques, example embodiments described herein comprise a smart mobile wallet management system configured to provide automatic issue resolution at a POS for a respective payment account associated with a user. In example embodiments, the smart mobile wallet management system may, at least in part, (i) receive a transaction attempt at a POS, where the transaction attempt is associated with a payment account of a user, (ii) determine whether the transaction attempt should be declined, where determining whether the transaction attempt should be declined may comprise: (a) determining a first transaction declination reason associated with the transaction attempt, (b) determining whether the first transaction declination reason is comprised in a transaction declination exception set associated with the payment account, and (c) in response to determining that the first transaction declination reason is comprised in the transaction declination exception set, authenticating the user based on an mDL associated with the user, and (iii) in response to successfully authenticating the user based on the mDL, allowing the transaction attempt.

Accordingly, the present disclosure sets forth systems, methods, and apparatuses that provide automatic issue resolution at a POS for use in executing various transactions (e.g., monetary transactions, mDL-based transactions). There are many advantages of these, and other embodiments described herein. One advantage the smart mobile wallet management system provides is an improvement to the functioning of the computing infrastructure of an enterprise (e.g., a bank or financial institution), such as by reducing the burden on computing resources. For instance, the smart mobile wallet management system described herein reduces the complexity of overriding or authorizing a transaction declination related to a transaction attempt by, among other things, automating processes such as identifying a smart mobile wallet associated with a user, authenticating a user based on an mDL stored in the smart mobile wallet associated with the user, determining whether a transaction declination reason associated with the transaction attempt is comprised within a transaction declination exception set, and providing secure access to one or more payment accounts via the smart mobile wallet associated with the user.

Another advantage of the smart mobile wallet management system, as described herein, is an improvement to network security technologies and/or authentication technologies by providing increased security for data, payment accounts, and/or valuable resources (e.g., financial resources) related to users and/or enterprises by utilizing mDLs associated with respective users to authenticate the respective users. In this regard, the smart mobile wallet management system may be employed to remotely authenticate a user based on a respective mDL. As will be described in greater detail below, utilizing mDLs that have been issued by legally entitled entities (e.g., government agencies) adds an additional layer of trust to each transaction and/or operation facilitated by the smart mobile wallet management system. Furthermore, utilizing mDLs to authenticate and/or verify users ensures that only intended parties (e.g., users, users) are able to manage issues (e.g., transaction declinations) for one or more payment accounts.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating a smart mobile wallet management system.

FIG. 2 illustrates a schematic block diagram of example circuitry embodying a system device that may perform various operations in accordance with some example embodiments described herein.

FIG. 3 illustrates a schematic block diagram of example circuitry embodying a user device that may perform various operations in accordance with some example embodiments described herein.

FIG. 4 illustrates an example flowchart diagram for providing automatic issue resolution in accordance with some example embodiments described herein.

FIG. 5 illustrates an example flowchart diagram for determining whether a user is at a location of a POS in accordance with some example embodiments described herein.

FIG. 6 illustrates another example flowchart diagram for determining whether a user is at a location of a POS in accordance with some example embodiments described herein.

FIG. 7 illustrates an example user interface associated with a user location verification indicia in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “user device” or “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server,” “server device,” or “server system” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “POS terminal” refers to any computing device capable of facilitating a transaction attempt associated with a respective merchant, retailer, service provider, and/or the like. In various examples, a POS terminal may be a kiosk, self-checkout machine, cash register, tablet computer, and/or any other suitable computing device capable of facilitating the sale of goods and/or services. In some examples, a POS terminal may embody and/or be integrated with various hardware components configured to accept one or more forms of payment such as a payment card (e.g., credit card, debit card), physical currency (e.g., paper currency, coin-based currency), and/or various digital payment methods (e.g., tap-to-pay methods associated with a user device (e.g., smart watch, mobile phone) and/or a smart mobile wallet associated a user device).

### System Architecture

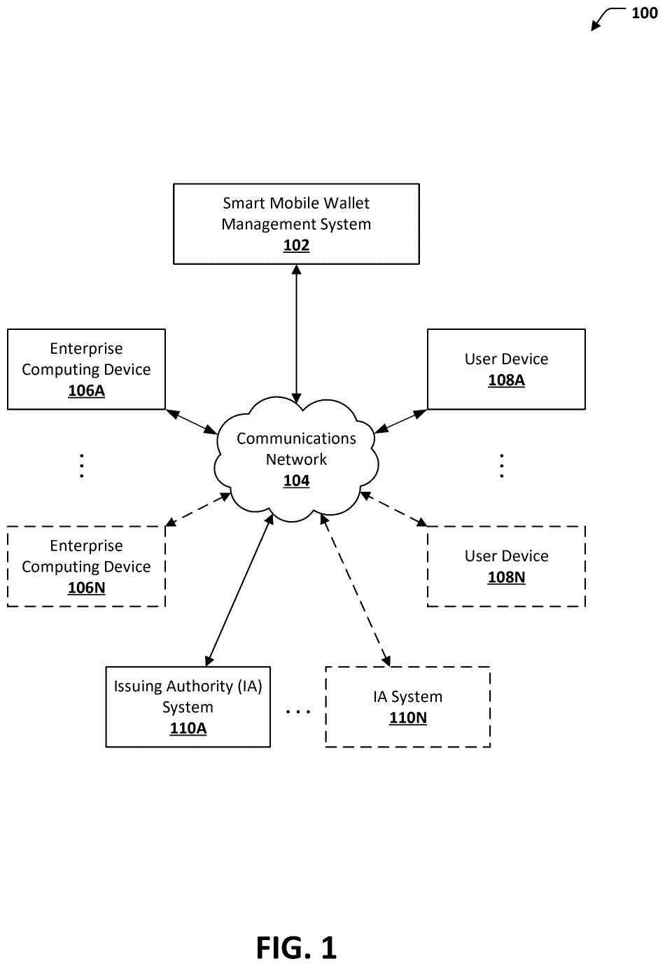

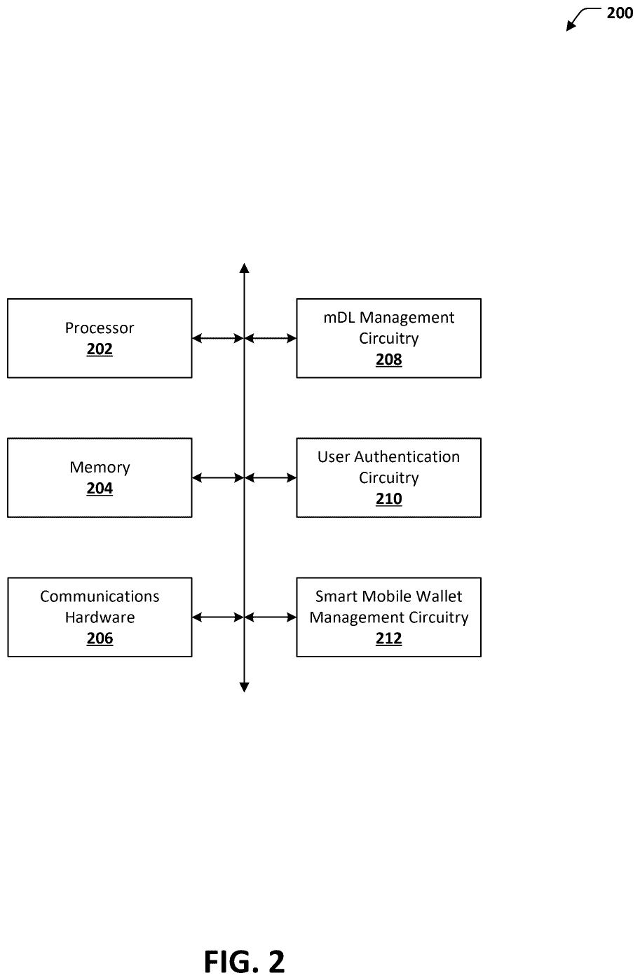

Example embodiments described herein may be implemented using any of a variety of computing devices or servers. To this end, FIG. 1 illustrates an example environment 100 within which various embodiments may operate. As illustrated, a smart mobile wallet management system 102 may receive and/or transmit information via communications network 104 (e.g., the Internet) with any number of other computing devices and/or computing systems, such as one or more of enterprise computing devices 106A-106N, user devices 108A-108N, and/or issuing authority (IA) systems 110A-110N. The smart mobile wallet management system 102 may be implemented as one or more computing devices or servers, which may be composed of a series of components. Particular components of the smart mobile wallet management system 102 are described in greater detail below with reference to apparatus 200 in connection with FIG. 2.

In various embodiments, the smart mobile wallet management system 102 may be associated with an enterprise (e.g., a financial institution, bank, and/or the like) and may be configured to manage various smart mobile wallet processes for users associated with said enterprise. For example, the smart mobile wallet management system 102 may be configured to manage, execute, initiate, and/or otherwise facilitate one or more automatic issue resolution processes, transaction declination reason exception configuration processes, user location verification processes, payment account linking processes, payment account transaction processes, smart mobile wallet processes, mDL authentication processes, user identity verification process, user authentication processes, and/or the like for a plurality of users associated with the respective enterprise.

In this regard, various users associated with an enterprise may interact with the smart mobile wallet management system 102 via a software application instance, where the software application instance may be configured to facilitate one or more of the various automatic issue resolution processes, transaction declination reason exception configuration processes, user location verification processes, smart mobile wallet processes, mDL authentication processes, and/or other processes described herein. In various embodiments, the software application instance associated with the smart mobile wallet management system 102 may be installed and/or downloaded to a user device (e.g., a user device 108A configured as a mobile device, laptop, and/or the like) and may present one or more user interface configurations to a respective user.

As such, the software application instance associated with the smart mobile wallet management system 102 may be configured to guide a user through the various steps of a user location verification process, a transaction declination reason exception configuration process, a payment account linking process, and/or the like that may require a user to be authenticated based on a corresponding mDL. For example, the software application instance associated with the smart mobile wallet management system 102 may be configured to cause display of various interactive user interface elements to the user that are configured to enable the user to manage one or more portions of smart mobile wallet data (e.g., payment account data, payment card data, data associated with a transaction declination reason exception, and/or the like) and/or user data (e.g., user attribute data, user profile data, user account data, and/or other user data).

In some embodiments, the software application instance may be configured to enable a user to access a smart mobile wallet (e.g., a digital wallet) configured to manage one or more of a user's mDL, payment accounts (e.g., credit accounts, checking accounts, savings accounts, investment accounts), and/or payment cards (e.g., credit cards, debit cards, and/or the like associated with the user's payment accounts) that are associated with a respective enterprise employing the smart mobile wallet management system 102. Additionally or alternatively, in various embodiments, the software application instance associated with the smart mobile wallet management system 102 may be configured to enable a user to access a software application framework related to a respective enterprise by, for example, providing (e.g., transmitting, enabling, toggling, configuring, etc.) one or more access permissions for a user device (e.g., a user device 108A) associated with the user, where the one or more access permissions enable the user device to access the software application framework associated with the enterprise.

As described herein, the smart mobile wallet management system 102 may be configured to receive transaction attempts associated with a user, where a transaction attempt may be an attempt to execute the purchase of one or more goods and/or services using a payment account associated with the user. As such, the smart mobile wallet management system 102 may be configured to integrate and/or communicate with one or more computing systems associated with an affiliated enterprise (e.g., a financial institution, banking institution, and/or the like) and/or one or more clearinghouses authorized to settle financial transactions (e.g., purchases, money transfers, etc.) between various merchants and the enterprise on behalf of one or more users. Furthermore, the smart mobile wallet management system 102 may be configured to determine whether a respective transaction attempt should be declined such that the transaction is terminated, or allowed such that funds are transferred from a respective payment account of the user to an account associated with the merchant involved in the transaction.

In some examples, the smart mobile wallet management system 102 may be configured to determine a respective transaction declination reason associated with a respective transaction attempt, where a transaction declination reason indicates a reason that the respective transaction attempt should be declined. In such examples, the smart mobile wallet management system 102 may be configured to generate and/or cause the transmission of a transaction declination notification associated with the transaction attempt, where the transaction declination notification describes a respective transaction declination reason and/or provides various data associated with the corresponding transaction attempt. In various examples, the smart mobile wallet management system 102 may be configured to provide (e.g., transmit, send, deliver, cause display, and/or the like) of the transaction declination reason to one or more of a POS terminal associated with the transaction attempt (e.g., a POS terminal located at a merchant location used to facilitate the transaction attempt), a user device (e.g., user device 108A) associated with the user, and/or a smart mobile wallet associated with the user.

Additionally, in some examples, the smart mobile wallet management system 102 may be configured to generate and/or manage a transaction declination exception set associated with a payment account. A transaction declination exception set may be a set of excusable transaction declination reasons that is utilized by the smart mobile wallet management system 102 when determining whether a respective transaction attempt should be allowed or denied. In this regard, the smart mobile wallet management system 102 may be configured to compare a transaction declination reason associated with a respective transaction attempt to a transaction declination exception set and, if the transaction declination reason is comprised within transaction declination exception set, allow the respective transaction attempt to be executed.

In various examples, a transaction declination exception set may include, but is not limited to, one or more of an unresolved payment method suspension (e.g., a user may have forgotten to close a lost or stolen payment card report), a premature payment method closure, an incorrect transaction fraud analysis executed by a system associated with an enterprise employing the smart mobile wallet management system 102 (e.g., the transaction attempt is mistakenly classified as fraudulent), and/or an invalid payment method status (e.g., an inactivated or deactivated payment card) associated with the payment account. In various examples, a transaction declination exception set may be associated with respective payment account information such as an account number, routing number, and/or other identifying information. Additionally, a transaction declination exception set may be associated with various identifying information associated with the corresponding payment account of the user, where such identifying information may be used by the smart mobile wallet management system 102 to link a transaction declination exception set to the payment account of the user.

Furthermore, a transaction declination exception set may be associated with one or more digital payment cards (e.g., fashioned after a conventional debit card, credit card, and/or the like) that may be stored by and/or linked to the one or more smart mobile wallets and utilized to execute various transactions via a user device (e.g., user device 108A). In this regard, the smart mobile wallet management system 102 may be configured to cause an appropriate amount of funds to be withdrawn from the one or more payment accounts associated with a transaction declination exception set based on any legitimate transaction executed utilizing a payment method (e.g., payment card, digital payment card, account number, routing number, and/or the like) associated with the one or more payment accounts.

In some embodiments, the smart mobile wallet management system 102 may be configured to facilitate the execution of one or more processes related to automatically resolving an issue at a POS for a respective user based on authenticating an mDL associated with the respective user. For example, the smart mobile wallet management system 102 may be configured to authenticate a user based on a respective mDL associated with the user based on a determination that a declination reason associated with a respective transaction attempt is comprised within a transaction declination exception set associated with a particular payment account. In this regard, the smart mobile wallet management system 102 may be configured to store, integrate with, manage, and/or utilize one or more mDLs (and/or data related to the one or more mDLs (e.g., mDL identifying information, cryptographic key information)) associated with a respective user in order to facilitate the various operations described herein. As used herein, the term “mDL” covers various mobile (e.g., digital) identity credential types associated with a respective user including mobile driver's licenses and mobile identification cards. An mDL may be an electronically managed data structure configured to be accessed, processed, and/or otherwise utilized by the smart mobile wallet management system 102 for various user authentication processes.

In this regard, an mDL may be configured to store or point to (e.g., programmatically reference) various credential data associated with a respective user including, but not limited to, personally identifiable information (PII) (e.g., given name, family name, name prefix, name suffix, driver's license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. Additionally, an mDL may be configured to store and/or point to various cryptographic key information (e.g., public key information used to identify the mDL, a corresponding user device, and/or a corresponding user) and/or originating IA data (e.g., cryptographic key information and/or identifying data associated with an originating IA).

An mDL may be issued (e.g., provisioned) to a respective user by an IA system 110A associated with a particular IA. An IA may be an entity that is legally entitled (or otherwise recognized as the relevant authority) to issue credentials, such as driver's licenses and/or other identification cards. An IA system 110A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 110A may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally or alternatively, in some embodiments, an mDL may be administered, managed, employed, and/or otherwise utilized by the smart mobile wallet management system 102 in compliance with various standards set forth by the American Association of Motor Vehicle Administrators (AAMVA). Additionally or alternatively, in some embodiments, an mDL may be administered, managed, employed, and/or otherwise utilized by the smart mobile wallet management system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver's license) associated with a user and may comprise and/or be associated with the same data as the legal credential. In some embodiments, an mDL associated with a user may be stored in a storage device (e.g., a server system) of an IA system 110A and one or more portions of credential data related to the mDL may be retrieved in real time, or near-real time, during a transaction associated with the user (e.g., an online transaction requiring user authentication, user age verification, and/or the like). Additionally or alternatively, once an mDL is issued to a user by a respective IA (e.g., by way of a corresponding IA system 110A), the mDL may be stored locally on a user device associated with the user (e.g., user device 108A) such that the mDL may be used without relying on a communications network (e.g., communications network 104). Additionally or alternatively, in some embodiments, an mDL may be stored in a smart mobile wallet associated with the user and managed by the smart mobile wallet management system 102, and the mDL may be accessed and/or utilized by the user via the smart mobile wallet to execute various mDL-based transactions.

In some examples, an IA may provision an mDL to a particular user device (e.g., user device 108A) associated with a user such that the mDL is associated with various user device identification data related to the particular user device (e.g., cryptographic identification data such as a public key). This may ensure that an mDL associated with a respective user cannot be transferred to multiple devices without authorization by the IA system (e.g., IA system 110A) and used in fraudulent transactions. Furthermore, associating an mDL with a particular user device (e.g., user device 108A) also enables the smart mobile wallet management system 102 and/or an IA system of an IA (e.g., IA system 110A) to verify that the intended user of the mDL is in possession of the mDL. Further still, associating an mDL with a particular user device (e.g., user device 108A) also ensures the safe transfer of sensitive credential data to and/or from the intended user of the mDL. In various examples, a user may store multiple copies of an mDL on multiple user devices (e.g., user devices 108A-108N). However, in such examples, each respective copy of the mDL may be cryptographically coupled to a respective user device by the IA system (e.g., IA system 110A) which provisioned the mDL. In this manner, each copy of the mDL can be independently verified against a respective user device to ensure that an mDL, or credential data associated with the mDL, cannot be transferred to unauthorized user devices.

An mDL may be associated with various mDL data security mechanisms used to ensure the validity of the mDL, authenticate an originating IA that issued the mDL, protect a user's personal data, and/or facilitate secure mDL-based transactions. In this regard, an mDL may be associated with a mobile security object (MSO) and/or various public and private cryptographic key information. An MSO is an electronically managed data structure that enables the authentication of the accuracy and origin of various credential data associated with the mDL during mDL-based transactions. In various examples, an MSO is associated with one or more portions of credential data related to the issue date, expiration date, user signature, and/or expected credential update time associated with the mDL. In various embodiments, the one or more portions of credential data associated with the MSO may be used to verify the validity and/or status of the mDL during various transactions. For example, if the credential data associated with the MSO indicates that the mDL is expired, the corresponding user may not be permitted to engage in one or more transactions using the mDL (e.g., one or more age-restricted purchase transactions).

Additionally, an mDL may be associated with various cryptographic key information (e.g., public/private key pair information) that may be utilized by the smart mobile wallet management system 102 to authenticate an originating IA that issued the mDL, verify one or more portions of credential data associated with an mDL, and/or facilitate various mDL-based transactions (e.g., retail purchase transactions, user authentication protocols, mDL data queries) for a user associated with the mDL. For example, an IA associated with a respective IA system 110A may be associated with a unique public key that may be utilized by the smart mobile wallet management system 102 to identify and/or authenticate the originating IA of a respective mDL. As such, in various examples, an mDL may be configured to store and/or point to the public key information associated with the IA from which the mDL was provisioned. Additional details related to the execution of various operations related to one or more mDLs associated with a user by the smart mobile wallet management system 102 will be described in greater detail herein with reference to FIGS. 2-7.

In some embodiments, the smart mobile wallet management system 102 further comprises and/or integrates with a storage device that comprises a distinct component from other components of the smart mobile wallet management system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Additionally or alternatively, the storage device may host the software executed to operate the smart mobile wallet management system 102. Additionally or alternatively, the storage device may store information relied upon during operation of the smart mobile wallet management system 102, such as various user data (e.g., user attribute data, user identification data), mDL data (e.g., cryptographic information, credential information), enterprise data (e.g., payment account data, user transaction data, product and/or service data), smart mobile wallet data (e.g., payment account data, payment card data, and/or the like associated with a user), distribution data, logistical data, legal data, software application framework data, etc.), and/or the like configured in various data formats to be utilized by the smart mobile wallet management system 102. In addition, the storage device may store control signals, device characteristics, and/or access credentials enabling interaction between the smart mobile wallet management system 102 and/or one or more of the enterprise computing devices 106A-106N or user devices 108A-108N.

In various embodiments, the one or more enterprise computing devices 106A-106N and/or the one or more user devices 108A-108N may be embodied by any computing devices known in the art. The one or more enterprise computing devices 106A-106N and/or the one or more user devices 108A-108N need not themselves be independent devices but may be peripheral devices communicatively coupled to other computing devices.

### Example Implementing Apparatuses

The smart mobile wallet management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 2-7. As illustrated in FIG. 2, the apparatus 200 may include processor 202, memory 204, communications hardware 206, mDL management circuitry 208, user authentication circuitry 210, and/or smart mobile wallet management circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to conduct various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application instance (e.g., a mobile application), dedicated client device, or the like. In some embodiments, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

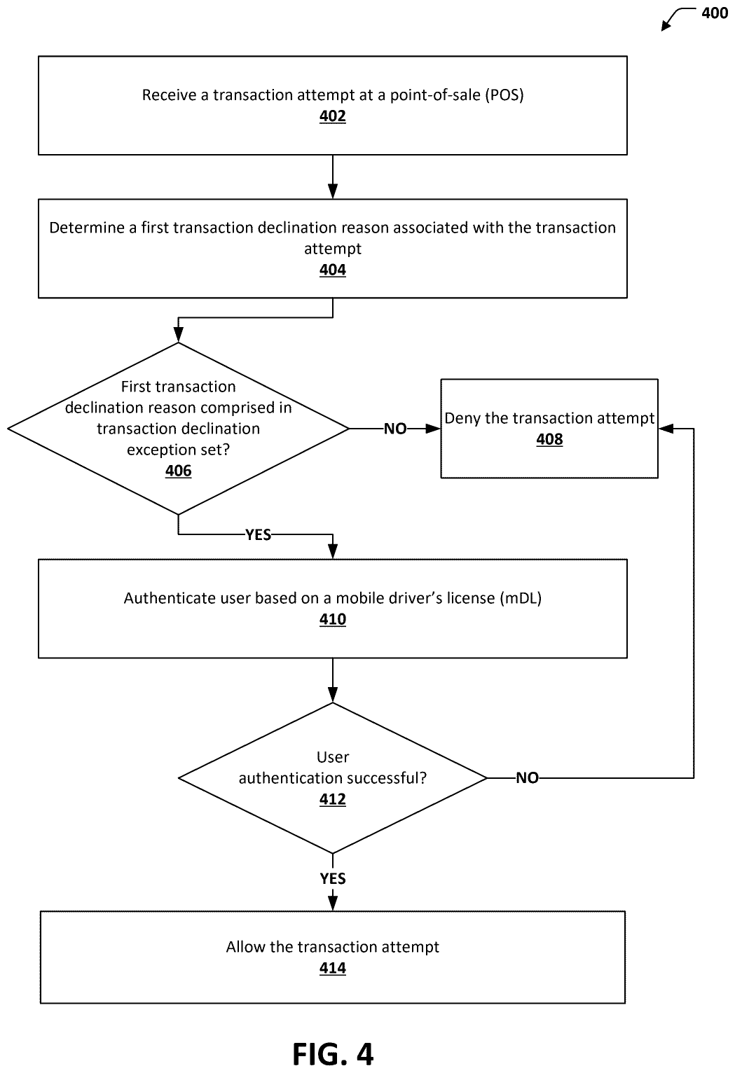

In addition, the apparatus 200 further comprises mDL management circuitry 208. In some embodiments, the mDL management circuitry 208 may be configured to facilitate the execution of one or more mDL authentication and/or IA authentication operations for an enterprise associated with the smart mobile wallet management system 102. Additionally, the mDL management circuitry 208 may utilize processor 202, memory 204, or any other hardware component included in the apparatus 200 to perform these operations, as described in connection with FIGS. 4-7 below. The mDL management circuitry 208 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the mDL management circuitry 208 may work in conjunction with the user authentication circuitry 210 and/or the smart mobile wallet management circuitry 212 in order to execute one or more of the methods described herein. For example, in some embodiments, the mDL management circuitry 208 may integrate with and/or otherwise leverage the user authentication circuitry 210 to facilitate the authentication of a user based on a respective mDL associated with the user.

In various circumstances, an IA system (e.g., IA system 110A) that previously issued an mDL to a respective user may periodically update credential data associated with the mDL (e.g., new user contact information, updated credential restrictions, updated credential endorsements). As such, the mDL management circuitry 208 may be configured to retrieve and/or receive updated credential data associated with a user's mDL from an IA system (e.g., IA system 110A) and facilitate the updating of the user's mDL based on the updated credential data. For example, if an mDL associated with a user is stored in a smart mobile wallet being managed by the smart mobile wallet management system 102, the mDL management circuitry 208 may be configured to receive updated credential data associated with the user's mDL from the originating IA system (e.g., IA system 110A) and subsequently update the user's mDL in the smart mobile wallet based on the updated credential data.

In some embodiments, the mDL management circuitry 208 may work in conjunction with the smart mobile wallet management circuitry 212 in order to update an mDL stored in a smart mobile wallet stored on a user device (e.g., user device 108A). In such embodiments, the mDL management circuitry 208 may be configured to query one or more storage devices (e.g., server systems) associated with an IA system (e.g., IA system 110A) in order to retrieve current and/or updated credential data in response to one or more interactions with a user interface associated with the smart mobile wallet. Additionally or alternatively, the mDL management circuitry 208 may be configured to periodically query to one or more storage devices (e.g., server systems) associated with an IA system (e.g., IA system 110A) based on a predefined schedule (e.g., once a day, once a week, once a month, once every 90 days) in order to retrieve current and/or updated credential data associated with a user′ mDL.

In various examples, an IA (e.g., a branch of the DMV) associated with a respective IA system (e.g., IA system 110A) may enforce various mDL data freshness requirements associated with the mDLs the IA system provisions to users. In this regard, an MSO associated with a respective mDL may indicate a technical validity period associated with the mDL (e.g., a 30-day validity period). As such, the mDL management circuitry 208 may utilize the technical validity period indicated by the MSO to ensure that the credential data associated with the mDL stored on a user device (e.g., user device 108A) is updated and/or current. For example, if the mDL management circuitry 208 determines that the technical validity period indicated by the MSO has expired, the mDL may be invalidated until the credential data associated with the mDL is refreshed (e.g., updated, verified) by the IA system 110A associated with the IA from which the mDL was issued. In some examples, the technical validity period of the mDL indicated by the MSO may be shorter than a validity period of the mDL and/or the corresponding physical legal credential associated with the mDL (e.g., an expiration date of a driver's license associated with the mDL).

For example, legal credentials (e.g., a driver's license and/or the corresponding mDL) are commonly associated with a relatively long validity period (e.g., five to seven years from the date of issue of the legal credential). However, problems may arise if an IA assigns various credential restrictions (e.g., driving restrictions) and/or credential endorsements (e.g., weighted vehicle endorsements) to a particular user's legal credential, yet the user fails to have the legal credential (e.g., a corresponding physical credential) updated with said credential restrictions and/or credential endorsements. To address such problems, if the mDL management circuitry 208 determines that the technical validity period indicated by the MSO of the mDL has expired, the corresponding mDL may flag the mDL such that the mDL will fail various authentication protocols during an mDL-based transaction.

In this regard, the mDL management circuitry 208 may be configured to facilitate the resetting of the technical validity period indicated by the MSO of the mDL in conjunction with a corresponding IA system (e.g., IA system 110A). Additionally or alternatively, the mDL management circuitry 208 may be configured to facilitate the updating and/or verification of the credential data associated with an mDL stored on a user device (e.g., user device 108A) each time the technical validity period associated with the MSO of the mDL is reset. This mDL data security mechanism ensures that the credential data associated with a user's mDL is always accurate and up to date.

As described herein, an mDL may be associated with various cryptographic key information (e.g., public/private key pair information) that may be utilized by the smart mobile wallet management system 102 to authenticate an originating IA that issued the mDL, verify one or more portions of credential data associated with an mDL, and/or facilitate various mDL-based transactions (e.g., retail purchase transactions, user authentication protocols, mDL data queries) for a user associated with the mDL. In this regard, the mDL management circuitry 208 may be configured to generate and/or transmit an IA authentication request comprising a public key associated with an IA to a corresponding IA system 110A in order to verify that a particular mDL was indeed provisioned by the IA associated with the IA system 110A.

In some examples, an mDL may only comprise (e.g., store, point to) identifying information related to a particular IA such that the mDL management circuitry 208 may be configured to first obtain a public key associated with the IA from a corresponding IA system 110A based on the identifying information. Once the public key information associated with the IA is obtained, the mDL management circuitry 208 may be configured to generate an IA authentication request comprising the public key of the IA and transmit the IA authentication request to the IA system 110A (e.g., via the communications network 104). As such, the mDL management circuitry 208 may be configured to receive, from an IA system (e.g., IA system 110A) and in response to the IA authentication request, one or more portions of data indicating whether the IA is a bona fide IA and/or whether the mDL indeed originated from the IA.

Once the mDL management circuitry 208 confirms the validity of the IA and/or confirms that a particular mDL associated with a user originated from the IA, the mDL management circuitry 208 may be configured to generate a digital token comprising cryptographic information (e.g., public key information) associated with the mDL and the user. Additionally, in some embodiments, the cryptographic information associated with the mDL and comprised in the digital token may be user device identification data by which a user device (e.g., user device 108A) of the respective user may be uniquely identified. In various examples, the mDL management circuitry 208 may generate and/or transmit the digital token to an IA system (e.g., IA system 110A) such that the IA system may decrypt the cryptographic information comprised in the digital token. In this manner, the IA system (e.g., IA system 110A) may authenticate (e.g., verify) one or more portions of credential data associated with the mDL and/or one or more portions of user device identification data associated with the user device (e.g., user device 108A). In this regard, the mDL management circuitry 208 may be configured to receive, from the IA system (e.g., IA system 110A) and in response to transmitting the digital token, one or more portions of data indicating whether the mDL and/or the user device (e.g., user device 108A) identified by the digital token is valid. Furthermore, in various examples, the mDL management circuitry 208 may be configured to receive, from the IA system (e.g., IA system 110A) and in response to transmitting the digital token, one or more portions of credential data associated with the mDL.

In some embodiments, the mDL management circuitry 208 may be configured to generate a digital token comprising cryptographic information (e.g., public key information) associated with an mDL and/or a user device (e.g., user device 108A) associated with a particular user in response to an mDL authentication request associated with the particular user. In some embodiments, the mDL authentication request may be a request to authenticate an mDL associated with the particular user and thereby authenticate the identity of the particular user for one or more mDL-based transactions. A respective mDL authentication request may comprise one or more of cryptographic information (e.g., public key information) associated with an mDL and/or a user device (e.g., user device 108A). Additionally or alternatively, a respective mDL authentication request may comprise one or more desired data elements (e.g., one or more desired portions of credential data) associated with the mDL, location data, user profile data, user account data, social media data, smart mobile wallet identification data, user device identification data, and/or the like associated with the particular user. In various examples, the mDL authentication request may be associated with a user associated with a payment account and may be triggered based on a determination made by the smart mobile wallet management system 102 that a transaction declination reason associated with a respective transaction attempt is comprised within a transaction declination exception set associated with the payment account.

In various examples, an mDL validity response received from an IA system (e.g., IA system 110A) based on a digital token generated by the mDL management circuitry 208 may comprise the entirety of the credential data associated with the mDL of the particular user. Additionally or alternatively, in various other examples, an mDL validity response received from an IA system (e.g., IA system 110A) based on a digital token generated by the mDL management circuitry 208 may comprise a verification of the desired credential data associated with the mDL that was indicated by an mDL authentication request. Additionally or alternatively, in various other examples, an mDL validity response received from an IA system (e.g., IA system 110A) based on a digital token generated by the mDL management circuitry 208 may comprise a verification of the user device identification data associated with the user device (e.g., user device 108A) of the particular user. For example, the mDL validity response may verify that the user device currently associated with the mDL is the same (e.g., intended) user device that the mDL was originally provisioned to. In this manner, the smart mobile wallet management system 102 may be configured to confirm the validity of the mDL data of an mDL associated with a particular user in order to authenticate the identity of the particular user. Additionally, this enables the smart mobile wallet management system 102 to confirm whether the intended user and/or user device (e.g., user device 108A) associated with the mDL is currently in possession of the mDL. These and other operations associated with the mDL management circuitry 208 will be described in further detail herein below with reference to FIGS. 4-7.

In addition, the apparatus 200 further comprises user authentication circuitry 210. In some embodiments, the user authentication circuitry 210 may be configured to facilitate the execution of one or more user authentication operations for an enterprise associated with the smart mobile wallet management system 102. Additionally, the user authentication circuitry 210 may utilize processor 202, memory 204, to perform these operations, as described in connection with FIGS. 4-7 below. The user authentication circuitry 210 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the user authentication circuitry 210 may work in conjunction with the mDL management circuitry 208 and/or the smart mobile wallet management circuitry 212 in order to execute one or more of the methods described herein. For example, in some embodiments, the user authentication circuitry 210 may integrate with and/or otherwise leverage the mDL management circuitry 208 to facilitate the identification and/or authentication of a user based on a respective mDL associated with the user.

Additionally, the user authentication circuitry 210 may be configured to identify a smart mobile wallet associated with a respective user. For example, the user authentication circuitry 210 may identify a smart mobile wallet associated with a user based on attribute data associated with the user. In some embodiments, user attribute data associated with a respective user may comprise user profile data, payment account data, user contact data, social media data, location data, and/or smart mobile wallet identification data associated with the respective user. In various examples, once the user authentication circuitry 210 identifies a smart mobile wallet that is associated with the respective user, the user authentication circuitry 210 may be configured to generate a user identification data request based on user attribute data associated with the respective user. The user authentication circuitry 210 may be configured to leverage the communications hardware 206 to transmit the user identification data request to the smart mobile wallet ostensibly associated with the respective user. Furthermore, the user authentication circuitry 210 may be configured to leverage the communications hardware 206 to receive user identification data from the smart mobile wallet ostensibly associated with the respective user based on the user identification data request.

In various examples, the user identification data associated with a respective user comprises cryptographic information associated with one or more of an mDL and/or a user device (e.g., user device 108A) associated with the respective user. In some embodiments the cryptographic information associated with the mDL and/or the user device may be a public key of a public/private key pair, where the public key is provisioned to the respective user by an IA upon issuance of the mDL. Such cryptographic information may be utilized by the smart mobile wallet management system 102 and/or an IA system (e.g., IA system 110A) associated with the IA that provisioned the mDL to identify and/or authenticate the mDL, one or more portions of desired mDL credential data, and/or the user device associated with the respective user. In this regard, the user authentication circuitry 210 may be configured to verify that the smart wallet ostensibly associated with the respective user is indeed associated with the respective user and that the smart mobile wallet management circuitry 212 may safely transmit and/or receive data (e.g., payment account data, transaction data) to and/or from the smart mobile wallet associated with the respective user.

Additionally or alternatively, in some embodiments, the user authentication circuitry 210 may be configured to facilitate execution of secondary user authentication of a respective user in addition to authenticating the respective user based on a corresponding mDL. In this regard, the user authentication circuitry 210 may be configured to facilitate the execution of a second factor of authentication including one or more of facial recognition, voice recognition, and/or biometric authentication techniques (e.g., fingerprint recognition, retina recognition, iris recognition). For example, the user authentication circuitry 210 may be configured to prompt a respective user via a user device (e.g., user device 108A) to authenticate themselves via a second factor of authentication (e.g., biometric authentication based on fingerprint data) before allowing the respective user to access a smart mobile wallet managed by the smart mobile wallet management system 102. Additionally or alternatively, in various embodiments, the user authentication circuitry 210 may be configured to prompt a respective user via a user device (e.g., user device 108A) to authenticate themselves via a second factor of authentication (e.g., voice recognition) either prior to or subsequent to authenticating the respective user based on an mDL associated with the respective user.

Additionally or alternatively, in some embodiments, the user authentication circuitry 210 may be configured to employ one or more facial recognition techniques to authenticate a user during a secondary user authentication process. For example, user authentication circuitry 210 may be configured to authenticate a respective user by matching image data related to the respective user's face that is captured in real time, or near-real time, (e.g., via a camera of a user device 108A) to user portrait image data associated with an mDL related to the respective user. In this regard, the user authentication circuitry 210 may be configured to generate an image matching score based on matching the image data of the user's face captured in real time, or near-real time, to the user portrait image data associated with the user's mDL.

As such, the user authentication circuitry 210 may be configured to determine if an image matching score (e.g., a numerical value or the like) satisfies a respective image matching threshold (e.g., a numerical value or the like). The image matching score may satisfy the respective image matching threshold if the image matching score is greater than or equal to the respective image matching threshold (e.g., to within an error value of +1%, +5%, or any other number). In other examples, the image matching score (e.g., a numerical value or the like) may satisfy the respective image matching threshold (e.g., a numerical value or the like) if the image matching score is less than or equal to the respective image matching threshold (e.g., to within an error value of ±1%, ±5%, or any other number). In this manner, the user authentication circuitry 210 may facilitate secondary authentication techniques in order to authenticate a respective user before allowing the respective user to access a respective smart mobile wallet via a user device (e.g., user device 108A). These and other operations associated with the user authentication circuitry 210 will be described in further detail herein below with reference to FIGS. 4-7.

In addition, the apparatus 200 further comprises smart mobile wallet management circuitry 212. In some embodiments, the smart mobile wallet management circuitry 212 may be configured to facilitate the execution of one or more smart mobile wallet operations and/or transactions for an enterprise associated with the smart mobile wallet management system 102. Additionally, the smart mobile wallet management circuitry 212 may utilize processor 202, memory 204, to perform these operations, as described in connection with FIGS. 4-7 below. The smart mobile wallet management circuitry 212 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the smart mobile wallet management circuitry 212 may work in conjunction with the mDL management circuitry 208 and/or the user authentication circuitry 210 in order to execute one or more of the methods described herein.

For example, in some embodiments, the smart mobile wallet management circuitry 212 may integrate with and/or otherwise leverage the user authentication circuitry 210 to facilitate the identification and/or authentication of a user in order to determine whether to allow or deny a transaction attempt associated with a respective payment account. In various examples, the smart mobile wallet management circuitry 212 may be configured to determine whether to deny a respective transaction attempt associated with a user based on a transaction declination reason associated with the respective transaction attempt. In this regard, the smart mobile wallet management circuitry 212 may be configured to determine a respective transaction declination reason associated with a respective transaction attempt, where a transaction declination reason indicates a reason that the respective transaction attempt should be declined.

To facilitate determining the reason a transaction attempt associated with a respective payment account should be declined, the smart mobile wallet management circuitry 212 may be configured to determine a current status of the payment account (e.g., active, inactive, closed, restricted, and/or the like), a status change associated with the payment account (e.g., a change from an active status to a restricted status), a current status of a payment method (e.g., a physical payment card, a digital payment card, and/or the like) associated with the payment account (e.g., active, inactive, lost, stolen, and/or the like), a status change associated with the payment method (e.g., a change from an active status to a lost status), one or more transaction limits (e.g., spending limits or caps) associated with the payment account, one or more transaction restrictions (e.g., merchant restrictions, good and/or service type restrictions, and/or the like), an available monetary balance associated with the payment account, and/or the like.

Additionally, the smart mobile wallet management circuitry 212 may be configured to compare a declination reason associated with a respective transaction attempt to a transaction declination exception set related to a respective payment account associated with the transaction attempt. In some examples, a user associated with the respective payment account may be enabled to configure a transaction declination exception set for the respective payment account based on one or more user preferences. For example, in some embodiments, one or more transaction declination exceptions associated with a respective payment account may be entered, selected, and/or otherwise indicated in whole or in part by the user via a user interface associated with a smart mobile wallet managed by the smart mobile wallet management system 102.

In some examples, in order to access a user interface to indicate various user preferences (e.g., preferred transaction declination exceptions), the user may be required to provide associated user credentials (e.g., password, personal identification number, biometric data, etc.) to login to an associated user account. In an instance in which the user is successfully authenticated using the provided user credentials, the user may then be allowed to proceed with configuring a transaction declination exception set associated with a respective payment account.

In this regard, the smart mobile wallet management circuitry 212 may be configured to leverage the processor 202, the memory 204, and/or the communications hardware 206 to generate, cause transmission of, and/or cause display of a plurality of interactive user interface elements on a user interface associated with a software application instance associated with the smart mobile wallet management system 102 on a user device 108A. The plurality of interactive user interface elements may be configured as one or more interactive text fields, buttons, selectable images, hyperlinks, radio buttons, sliders, embedded multimedia modules, charts, graphs, prompts, notifications, banners, instructions, and/or the like configured to initiate execution of one or more commands (e.g., executable software instructions) based on an interaction (e.g., user input) with the plurality of interactive user interface elements.

Additionally or alternatively, the smart mobile wallet management circuitry 212 may be configured to leverage the processor 202, the memory 204, and/or the communications hardware 206 to generate and/or configure (e.g., instantiate, update) a smart mobile wallet comprising one or more of a plurality of interactive user interface elements. The smart mobile wallet management circuitry 212 may generate a smart mobile wallet for a respective user based on one or more user attributes associated with the respective user and/or enterprise data corresponding to the respective user stored by the enterprise associated with the smart mobile wallet management system 102. Additionally, the smart mobile wallet management circuitry 212 may be configured to leverage the processor 202, the memory 204, and/or the communications hardware 206 to provide the smart mobile wallet to a user device (e.g., user device 108A) associated with the respective user such that the respective user is enabled to interact with and/or utilize the smart mobile wallet to execute various operations, transactions, and/or the like.

For example, based on one or more interactions with a respective smart mobile wallet, the smart mobile wallet management circuitry 212 may be configured to generate and/or configure one or more transaction declination exceptions for a transaction declination exception set associated with a respective payment account of a user (e.g., a bank account managed by a financial institute with which the user is a member). Additionally or alternatively, the smart mobile wallet management circuitry 212 may be configured to facilitate the configuration, reconfiguration, update and/or management of a transaction declination exception set, a payment account, a digital payment card, a physical payment card, and/or the like via a smart mobile wallet associated with the respective user. Additionally or alternatively, the smart mobile wallet management circuitry 212 may be configured to display various digital representations and/or data related to a transaction declination exception set, a payment account, a digital payment card, a physical payment card, and/or the like via a smart mobile wallet associated with the respective user.

Additionally or alternatively, in some embodiments, the smart mobile wallet management circuitry 212 may be configured with default and/or static values for one or more transaction declination exception sets. As such, the smart mobile wallet management circuitry 212 may use these values in an instance in which a user does not provide values for a transaction declination exception set or if the transaction declination exception set values cannot be selected by the user, such as for security reasons. Thus, the smart mobile wallet management circuitry 212 may generate a transaction declination exception set that is compliant with one more governmental and/or institutional policies and/or regulations.

Furthermore, based on one or more interactions with a respective smart mobile wallet, the smart mobile wallet management circuitry 212 may be configured to facilitate one or more financial transactions for a respective user. The one or more financial transactions may involve the settlement of a payment (e.g., the withdrawal and transfer of funds) initiated by a respective user with a particular merchant (e.g., an online merchant, a brick-and-mortar retailer). In this regard, the smart mobile wallet management circuitry 212 may be configured to utilize account data (e.g., user account identifier information, user account routing information, and/or the like) associated with one or more means of payment (e.g., a payment card, payment account routing information) stored in and/or associated with a smart mobile wallet of a respective user to ensure an appropriate amount of funds is transferred from the respective user to the merchant.

In this regard, the smart mobile wallet management circuitry 212 may be configured to determine whether a payment account is linked to a smart mobile wallet associated with the user. In an instance in which the payment account is not linked to the smart mobile wallet, the smart mobile wallet management circuitry 212 may be configured to leverage the communications hardware 206 to receive, retrieve, and/or otherwise obtain payment account data associated with the payment account from a user device (e.g., user device 108A) associated with the user. In some examples, the payment account data may comprise one or more of an account identifier, card number, account number, card verification value (CVV), user account information (e.g., username, password), and/or the like. Once the payment account data is acquired, the smart mobile wallet management circuitry 212 may be configured to link the payment account to the smart mobile wallet such that one or more transaction attempts associated with the payment account may be facilitated via the smart mobile wallet.

Additionally, in various examples, the smart mobile wallet management circuitry 212 may be configured to determine whether a user associated with a respective transaction attempt is at a location of a POS (e.g., a POS terminal) associated with the respective transaction attempt. In this regard, in some examples, the smart mobile wallet management circuitry 212 may be configured to generate and/or provide user location verification indicia to POS terminal associated with a merchant involved in the respective transaction attempt at the time the transaction attempt is being executed. Based on a user interaction with the user location verification indicia, the smart mobile wallet management circuitry 212 may be configured to determine that an appropriate user (e.g., the user associated with the corresponding payment account used during the transaction attempt) is at the location of the POS (e.g., a POS terminal) associated with the transaction attempt.

In various examples, the user location verification indicia may be configured as one or more digital representations of a quick response (QR) code, data matrix, Aztec code, PDF417 code, databar, codabar, barcode, and/or the like that may be scannable by an imaging device associated with a user device (e.g., user device 108A) such as a rear-facing camera of a mobile device. Additionally or alternatively, in some examples, the user location verification indicia may comprise text, images, watermarks, logos, icons, and/or the like associated with one or more of the transaction attempt, the merchant associated with the transaction attempt, and/or the enterprise associated with the smart mobile wallet management system 102.

In various examples, the smart mobile wallet management circuitry 212 may be configured to generate unique user location verification indicia for a respective transaction attempt associated with a particular user. In this regard, the user location verification indicia may comprise encoded data associated with the respective transaction attempt, encoded data associated with the user (e.g., user attribute data, user payment account data), encoded data associated the merchant related to the transaction attempt, and/or the like. As such, the encoded information associated with the user location verification indicia may be utilized to confirm, verify, and/or otherwise authenticate the user associated with the respective transaction attempt.

In some examples, the user location verification indicia are configured to be displayed via an electronic display associated with a POS terminal associated with a respective transaction attempt. Furthermore, the user location verification indicia may be configured to cause the generation and/or transmission of an affirmative user location acknowledgement (e.g., a digital message, notification, indication, and/or the like) to the smart mobile wallet management system 102 indicating that the location of the user is associated with the POS terminal. In some examples, the affirmative user location acknowledgement may be used by the smart mobile wallet management circuitry 212 and/or the user authentication circuitry 210 to authenticate the user associated with the transaction attempt such that the transaction attempt may be allowed.

Additionally or alternatively, in some examples, the smart mobile wallet management circuitry 212 may be configured to determine if a user device (e.g., user device 108A) associated with the user is at a location of a POS associated with a respective transaction attempt by comparing the location of the user to a location of the POS (e.g., a POS terminal, a coordinate position associated with a computing device (e.g., laptop computer) that executed the transaction attempt, and/or the like). In this regard, the smart mobile wallet management circuitry 212 may be configured to determine whether the distance between the user and the POS (e.g., a POS terminal, a computing device (e.g., laptop computer) used to execute the transaction attempt, and/or the like) satisfies a predetermined distance threshold such that it may be verified that the user is indeed at the POS associated with a respective transaction attempt. The distance between the user and the POS may satisfy the respective predetermined distance threshold if the distance between the user and the POS is greater than or equal to the respective predetermined distance threshold (e.g., to within an error value of ±1%, ±5%, or any other number). In other examples, the distance between the user and the POS (e.g., a numerical value or the like) may satisfy the respective predetermined distance threshold (e.g., a numerical value or the like) if the distance between the user and the POS is less than or equal to the respective predetermined distance threshold (e.g., to within an error value of ±1%, ±5%, or any other number). These and other operations associated with the smart mobile wallet management circuitry 212 will be described in further detail herein below with reference to FIGS. 4-7.

Although components 202-212 are described in part using functional language, it will be understood that the particular implementations necessarily include the use of particular hardware. It should also be understood that certain of these components 202-212 may include similar or common hardware. For example, the mDL management circuitry 208, the user authentication circuitry 210, and/or the smart mobile wallet management circuitry 212 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition, refer to software instructions that configure the hardware components of the apparatus 200 to perform the various functions described herein.

Although the mDL management circuitry 208, the user authentication circuitry 210, and/or the smart mobile wallet management circuitry 212 may leverage processor 202, memory 204, and/or communications hardware 206 as described above, it will be understood that any of the mDL management circuitry 208, the user authentication circuitry 210, and/or the smart mobile wallet management circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the mDL management circuitry 208, the user authentication circuitry 210, and/or the smart mobile wallet management circuitry 212 comprise particular machinery designed for performing the functions described herein in connection with such elements of apparatus 200.

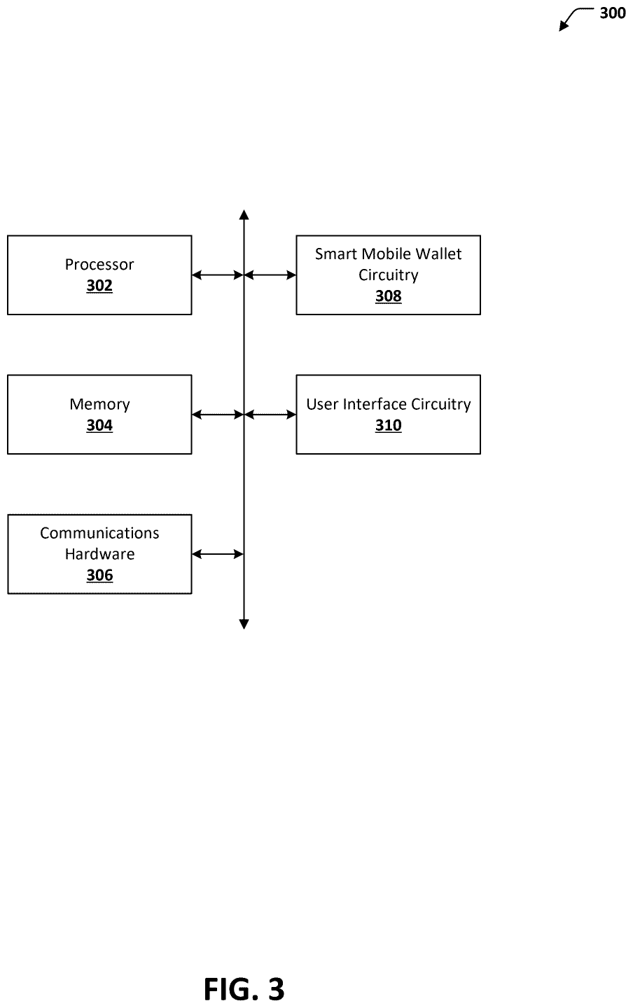

As illustrated in FIG. 3, an apparatus 300 is shown that represents an example enterprise computing device (e.g., any of enterprise computing devices 106A-106N) or an example user device (e.g., any of user devices 108A-108N). The apparatus 300 includes processor 302, memory 304, and communications hardware 306, each of which is configured to be similar to the similarly named components described above in connection with FIG. 2. Additionally, the apparatus 300 may also include smart mobile wallet circuitry 308, and/or user interface circuitry 310, each of which may be configured to facilitate the execution of the various methods described herein. For example, the smart mobile wallet circuitry 308, and/or the user interface circuitry 310 may be configured to work in conjunction to facilitate user interaction with the smart mobile wallet management system 102. Furthermore, the smart mobile wallet circuitry 308 may be configured to manage and/or facilitate one or more actions related to a smart mobile wallet associated with a respective user on a user device (e.g., user device 108A) that has been provisioned by the smart mobile wallet management system 102. In some embodiments, the smart mobile wallet circuitry 308 may utilize processor 302, memory 304, or any other hardware component included in the apparatus 300 to perform one or more of the operations described in connection with FIGS. 4-7 below.

In some embodiments, the smart mobile wallet circuitry 308 includes hardware components designed for generating one or more requests configured to initiate various operations to be executed by the smart mobile wallet management system 102. For example, the smart mobile wallet circuitry 308 may be configured to facilitate the generation of one or more transaction declination exceptions for a transaction declination exception set associated with a respective payment account based on one or more interactions (e.g., user input, user selection) with a smart mobile wallet on a user device (e.g., user device 108A). As described herein, the transaction declination exception set may be a set of excusable transaction declination reasons that is utilized by the smart mobile wallet management system 102 when determining whether a respective transaction attempt should be allowed or denied. In some embodiments, the one or more transaction declination exceptions associated with a transaction declination exception set may be entered, selected, and/or otherwise indicated in whole or in part by the user (e.g., via a user interface associated with a smart mobile wallet). Additionally or alternatively, the one or more transaction declination exceptions associated with a transaction declination exception set may be automatically populated in whole or in part by the smart mobile wallet circuitry 308.

Additionally, in various examples, the smart mobile wallet circuitry 308 may be configured to generate responses to various queries, prompts, and/or notifications. For instance, the smart mobile wallet circuitry 308 may be configured to generate and/or cause transmission of one or more affirmative user location acknowledgements in response to an interaction with one or more user location verification indicia. In some examples, the one or more user location verification indicia may be displayed on an electronic display of POS terminal that is being utilized to execute a respective transaction attempt. For example, a POS terminal associated with a merchant may be configured to receive user location verification indicia from the smart mobile wallet management system 102, where the user location verification indicia are configured to facilitate the confirmation that the user is at the POS terminal during the transaction attempt.

In this regard, the smart mobile wallet circuitry 308 may be configured to generate an affirmative user location acknowledgement that confirms user location and presence during transaction attempt. In various examples, the affirmative user location acknowledgement may be an electronically managed data structure configured to comprise various data associated with the user (e.g., user attribute data), data associated with a user device (e.g., user device identification data, location coordinate data) related to the user (e.g., user device 108A), data associated with the respective transaction attempt (e.g., location coordinate data, transaction amount, merchant identification data), data associated with the POS terminal associated with the merchant (e.g., identification data, location coordinate data, and/or the like associated with the POS terminal), and/or the like.

As described herein, an affirmative user location acknowledgement may be generated in response to an interaction with user location verification indicia displayed via an electronic display of a POS terminal. A such, the smart mobile wallet circuitry 308 may be configured to facilitate said interaction with the user location verification indicia. For example, the smart mobile wallet circuitry 308 may be configured to capture and/or scan one or more portions of image input data representative of user location verification indicia based on one or more interactions with a software application instance associated with the smart mobile wallet management system 102. In some examples, the image input data representative of the user location verification indicia may be captured by an imaging device (e.g., rear-facing camera) of a user device (e.g., user device 108A) associated with a user. In various examples, the image input data representative of the user location verification indicia may include one or more portions of still image data (e.g., pixels, contour lines, color gradients, contrast regions, etc.) and/or one or more portions of video data (e.g., video frames, pixels, contour lines, color gradients, contrast regions etc.) captured with respect to the QR codes, barcodes, text, images, watermarks, logos, icons, and/or the like associated with the user location verification indicia.

As a non-limiting example, the smart mobile wallet circuitry 308 may be configured to facilitate the alignment of user location verification indicia within the field-of-view of a camera (e.g., a rear-facing camera) embodied by a user device (e.g., user device 108A). For instance, the smart mobile wallet circuitry 308 may be configured to cause display of a digital representation of a frame, border, outline, and/or the like via the user interface of a software application instance associated with the smart mobile wallet management system 102 on an electronic display (e.g., touchscreen, liquid crystal display (LCD), etc.) of the user device (e.g., user device 108A). In such embodiments, the smart mobile wallet circuitry 308 may overlay a digital representation of a frame atop a real time (or near-real time) video data feed being captured via the rear-facing camera of the user device, where the video data feed being captured is utilized to align the user location verification indicia within the digital representation of the frame. Once aligned, the smart mobile wallet circuitry 308 may be configured to record, scan, capture, and/or otherwise record image data associated with the user location verification indicia.

Additionally, the smart mobile wallet circuitry 308 may be configured to decode the user location verification indicia in order to parse various data associated with the user location verification indicia. As such, the decoded data associated with the user location verification indicia (e.g., decoded data associated with the respective transaction attempt, decoded data associated with the user (e.g., user attribute data, user payment account data), decoded data associated the merchant related to the transaction attempt, and/or the like) may be utilized by the smart mobile wallet circuitry 308 to facilitate the generation of an affirmative user location acknowledgement. The smart mobile wallet circuitry 308 may then cause transmission of the affirmative user location acknowledgement to the smart mobile wallet management system 102 for processing and authentication of the user associated with the transaction attempt.

Furthermore, the smart mobile wallet circuitry 308 of a user device (e.g., user device 108A) may be configured to generate an affirmative user location acknowledgement comprising one or more portions of mDL data associated with the mDL of the user. As such, the affirmative user location acknowledgement may comprise one or more of cryptographic key information (e.g., public key information used to identify the mDL, a corresponding user device (e.g., user device 108A), and/or a corresponding user), originating IA data (e.g., cryptographic key information and/or identifying data associated with an originating IA), and/or other identifying data associated with the mDL of the user that is stored in the smart mobile wallet.

Furthermore, in various examples, an affirmative user location acknowledgement may be configured to comprise and/or trigger the transmission and/or execution of one or more mDL authentication requests associated with a respective user. The one or more mDL authentication requests may be requests to verify and/or authenticate the respective user based on a corresponding mDL. For example, as described herein, the smart mobile wallet management system 102 may be configured to generate and/or transmit user identification data requests (e.g., user identification data requests, user identification data requests, and/or the like) to respective smart mobile wallets to facilitate the one or more operations described herein. As such, the smart mobile wallet circuitry 308 may be configured to generate and/or cause transmission of a response providing user identification data comprised in and/or associated with a smart mobile wallet on the user device (e.g., user device 108A).

As described herein, the user identification data associated with a respective user may comprise cryptographic information associated with one or more of an mDL and/or a user device (e.g., user device 108A) associated with the respective user. In some embodiments the cryptographic information associated with the mDL and/or the user device may be a public key of a public/private key pair, where the public key is provisioned to the respective user by an IA upon issuance of the mDL. Such cryptographic information may be utilized by the smart mobile wallet management system 102 and/or an IA system (e.g., IA system 110A) associated with the IA that provisioned the mDL to identify and/or authenticate the mDL, one or more portions of desired mDL credential data, and/or the user device associated with the respective user.

Additionally, the smart mobile wallet circuitry 308 may be configured to facilitate various actions associated with one or more payment methods associated with a smart mobile wallet on a respective user device (e.g., user device 108A). For example, the smart mobile wallet circuitry 308 may be configured to facilitate the management of, utilization of, and/or interaction with one or more of a payment card (e.g., a credit card, debit card), payment account (e.g., checking account, savings account), and/or user account affiliated with an enterprise (e.g., financial institution) associated with the smart mobile wallet management system 102. For instance, in some embodiments, the smart mobile wallet circuitry 308 may be configured to enable a user to check an account balance, view historical transactions, initiate a payment transaction, stop a payment transaction, transfer funds, link a payment account or method, unlink a payment account or method, settle a payment transaction at a POS associated with a merchant, settle an online payment transaction, and/or the like via the smart mobile wallet on a respective user device (e.g., user device 108A).

Furthermore, the smart mobile wallet circuitry 308 may be configured to facilitate various actions associated with an mDL of a respective user that is stored in and/or associated with the smart mobile wallet on a respective user device (e.g., user device 108A). For example, the smart mobile wallet circuitry 308 may be configured to cause an mDL to be updated, verified, authenticated and/or deleted from the smart mobile wallet. In some embodiments, the smart mobile wallet circuitry 308 may be configured to leverage the communications hardware 306 to communicate with an IA system (e.g., IA system 110A) in order to retrieve and/or receive one or more portions of mDL data (e.g., updated credential data) associated with an mDL stored in the smart mobile wallet. Additionally or alternatively, the smart mobile wallet circuitry 308 may be configured to leverage the communications hardware 306 to cause one or more components of the apparatus 200 (e.g., the mDL management circuitry 208) to facilitate the update of an mDL stored in a smart mobile wallet of a respective user device (e.g., user device 108A).

In addition, the apparatus 300 may also include the user interface circuitry 310, which includes hardware components designed for receiving user inputs and/or rendering virtual graphics outputs. The user interface circuitry 310 may utilize processor 302, memory 304, or any other hardware component included in, or integrated with, the apparatus 300 to perform these operations, as described in connection with FIGS. 4-7 below. The user interface circuitry 310 may further utilize communications hardware 306 to transmit data representative of a user input and/or receive data to render as a virtual graphics output or may otherwise utilize processor 302 and/or memory 304 to generate data representative of a user input and/or generate virtual graphics output, e.g., from based on received data. The user interface circuitry 310 may comprise one or more of a keyboard, pointing device, touchscreen, microphone with speech recognition interface, one or more cameras, and/or one or more other input devices capable of receiving various different user inputs. In addition, the user interface circuitry 310 may comprise a display device including one or more of a screen with graphical user interface (GUI), speaker, light-emitting diode (LED) display, organic LED (OLED) display, LCD display, touchscreen, haptic technology device, and/or other output device capable of rendering information to a user.

Additionally, the user interface circuitry 310 may utilize processor 302, memory 304, smart mobile wallet circuitry 308, or any other hardware component included in, or integrated with, the apparatus 300 to run, host, configure, and/or otherwise execute one or more operations, instructions, and/or commands related to a software application instance and/or smart mobile wallet associated with the smart mobile wallet management system 102. For example, the user interface circuitry 310 may be configured allow a user to interact with the smart mobile wallet management system 102 via the software application instance in order to facilitate one or more transaction declination exception configuration operations, smart mobile wallet operations, user authentication operations, and/or any of the other methods described herein.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200, or 300, may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Operations

Turning to FIGS. 4-6, example flowcharts are illustrated that contain example operations implemented by example embodiments described herein. The operations illustrated in FIGS. 4-6 may, for example, be performed by a system device (e.g., server, etc.) of the smart mobile wallet management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, mDL management circuitry 208, user authentication circuitry 210, smart mobile wallet management circuitry 212, and/or any combination thereof. It will be understood that user interaction with the smart mobile wallet management system 102 may occur directly via communications hardware 206, or may instead be facilitated by a separate computing device (e.g., any of enterprise computing devices 106A-106N, and/or user devices 108A-108N shown in FIG. 1, which may in turn be embodied by an apparatus 300, which is shown and described in connection with FIG. 3), and which may have similar or equivalent physical componentry facilitating such user interaction.

Turning first to FIG. 4, flowchart 400 illustrates a process comprising example operations for providing automatic issue resolution for one or more payment accounts associated with a user.

As shown by operation 402, the apparatus 200 may include means, such as processor 202, memory 204, communications hardware 206, and/or the like for receiving a transaction attempt associated with a payment account at a POS. In various examples, a transaction attempt may be an attempt to purchase goods and/or services using funds associated with the payment account and may executed in-person (e.g., via POS terminal at a physical retail location) or remotely via a communications network 104 (e.g., via a website, mobile application, and/or the like). A transaction attempt may be associated with various data including, but not limited to, a transaction amount (e.g., a monetary value associated with one or more goods and/or services), a payment method (e.g., data related to a payment account, payment card, and/or the like), a merchant identifier, a POS location (e.g., a merchant location, a user location and/or the like indicated by global positioning system (GPS) coordinates), a description of one or more goods and/or services being purchased, and/or the like.

As described herein, the smart mobile wallet management circuitry 212 may be configured to generate and provide a software application instance associated with the smart mobile wallet management system 102 to a user device (e.g., user device 108A) where the software application instance may be configured to enable a user to access a smart mobile wallet configured to manage one or more respective payment accounts, payment cards, mDLs, and/or the like. As such, once a transaction declination exception set is generated and/or enabled for one or more payment methods (e.g., payment accounts, payment cards, and/or the like) comprised in a smart mobile wallet associated with the user, the user may utilize the payment methods in an expected manner. In this regard, the communications hardware 206 may be configured to receive a transaction attempt associated with the payment account configured with a transaction declination exception set, where the transaction attempt is generated based on a user interaction with a smart mobile wallet.

As shown by operation 404, the apparatus 200 may include means, such as processor 202, memory 204, smart mobile wallet management circuitry 212, and/or the like for determining a first transaction declination reason associated with the transaction attempt. As described herein, the smart mobile wallet management circuitry 212 may be configured to determine whether a respective transaction attempt should be allowed or declined. As such, the smart mobile wallet management circuitry 212 may detect and/or determine one or more transaction declination reasons that indicate that the respective transaction attempt should be declined.

In this regard, the smart mobile wallet management circuitry 212 may be configured to determine a current status of the payment account (e.g., active, inactive, closed, restricted, and/or the like), a status change associated with the payment account (e.g., a change from an active status to a restricted status), a status of a payment method (e.g., a physical payment card, a digital payment card, and/or the like) associated with the payment account (e.g., active, inactive, lost, stolen, and/or the like), a status change associated with the payment method (e.g., a change from an active status to a lost status), one or more transaction limits (e.g., spending limits or caps) associated with the payment account, one or more transaction restrictions (e.g., merchant restrictions, good and/or service type restrictions, and/or the like), an available monetary balance associated with the payment account, and/or the like.

In some examples, if the smart mobile wallet management circuitry 212 determines one or more issues related to the current status and/or a changed status of the payment account, a current status and/or a changed status of the payment method associated with the payment account, the smart mobile wallet management circuitry 212 may flag the respective transaction attempt for denial for those reasons. Additionally, in various other examples, if the smart mobile wallet management circuitry 212 determines that a transaction amount the transaction attempt exceeds one or more transaction limits and/or an available monetary balance associated with the payment account, the smart mobile wallet management circuitry 212 may flag the respective transaction attempt for denial for those reasons. Additionally, in various other examples, if the smart mobile wallet management circuitry 212 determines that the transaction attempt violates one or more transaction restrictions associated with the payment account (e.g., the transaction attempt is associated with an unapproved merchant, good, and/or service), the smart mobile wallet management circuitry 212 may flag the respective transaction attempt for denial for those reasons.

As shown by operation 406, the apparatus 200 may include means, such as processor 202, memory 204, smart mobile wallet management circuitry 212, and/or the like for determining whether the first transaction declination associated with the transaction attempt is comprised in a transaction declination exception set associated with the payment account utilized during the transaction attempt. For example, the smart mobile wallet management circuitry 212 may be configured to compare the declination reason associated with the respective transaction attempt to a transaction declination exception set associated with the payment account utilized during with the transaction attempt.

As described herein, the transaction declination exception set associated with the payment account may be a set of excusable transaction declination reasons that override a potential denial of a respective transaction attempt. In various examples, one or more transaction declination exceptions comprised in a transaction declination exception set may indicate one or more issues, circumstances, and/or events, that would typically lead to a transaction denial that a user and/or enterprise is willing to allow, permit, and/or excuse such that the transaction attempt may procced and one or more goods and/or services associated with the transaction attempt may be purchased.

For example, as described herein, the transaction declination exception set may comprise a set of excusable transaction declination reasons, and where the set of excusable transaction declination reasons comprises one or more of an unresolved payment method suspension (e.g., a user may have forgotten to close a lost or stolen payment card report), a premature payment method closure, an incorrect transaction fraud analysis executed by a system associated with an enterprise employing the smart mobile wallet management system 102 (e.g., the transaction attempt is mistakenly classified as fraudulent), and/or an invalid payment method status (e.g., an inactivated or deactivated payment card) associated with the payment account.

In addition to the excusable transaction declination reasons associated with the transaction declination exception set, the smart mobile wallet management circuitry 212 may also be configured to compare the transaction declination reason(s) associated with the respective transaction attempt to a set of inexcusable transaction declination reasons. Non-limiting examples of inexcusable transaction declination reasons may include a lack of sufficient funds in the payment account needed to execute the transaction attempt, a fraud analysis associated with the transaction attempt that indicates severe and/or security-critical fraud (e.g., identity theft, credit fraud, and/or the like), and/or violation of a predetermined expiration date associated with the payment account (e.g., a payment account and/or payment method that has been deactivated, closed, and/or the like for one year, two years, five years, and/or any appropriate, predetermined amount of time).

In various examples, the smart mobile wallet management circuitry 212 may be configured to generate and/or cause the transmission of a transaction declination notification detailing the first transaction declination reason to one or more computing devices during the transaction attempt. For example, the smart mobile wallet management circuitry 212 may be configured to leverage the communications hardware 206 to provide a transaction declination notification to one or more of the POS terminal associated with the transaction attempt, a user device associated with the user (e.g., user device 108A), and/or a smart mobile wallet associated with the user at a time when the transaction declination reason associated with the transaction attempt is determined. In this manner, the user may be made aware of the reason(s) why the transaction attempt may be declined. Furthermore, in an example in which the transaction declination reason is comprised within the transaction declination exception set, the smart mobile wallet management circuitry 212 may be configured to generate and/or cause the transmission of a transaction declination notification detailing that first transaction declination reason is comprised in the transaction declination exception set and the transaction will be subsequently allowed.

As shown, if the smart mobile wallet management circuitry 212 determines that the first transaction declination reason associated with the transaction attempt is not comprised in the transaction declination exception set associated with the payment account, the process may proceed to operation 408. Alternatively, if the smart mobile wallet management circuitry 212 determines that the first transaction declination reason associated with the transaction attempt is comprised in the transaction declination exception set associated with the payment account, the process may proceed to operation 410.

As shown by operation 408, the apparatus 200 may include means, such as processor 202, memory 204, communications hardware 206, smart mobile wallet management circuitry 212, and/or the like for denying the transaction attempt. For example, if it is determined that the first transaction declination reason associated with the transaction attempt is not comprised in the transaction declination exception set, the smart mobile wallet management circuitry 212 may be configured to deny (or flag for denial) the transaction attempt such that the transaction is cancelled, and no money is withdrawn from the payment account associated with the transaction attempt. As such, the smart mobile wallet management circuitry 212 may be configured to leverage the communications hardware 206 to provide instructions and/or information to one or more computing devices associated with the merchant associated with the transaction attempt directing the merchant (or a clearinghouse, bank, or financial institution related to the merchant) to cancel, void, and/or otherwise disallow the transaction attempt.

As shown by operation 410, the apparatus 200 may include means, such as processor 202, memory 204, communications hardware 206, mDL management circuitry 208, user authentication circuitry 210, smart mobile wallet management circuitry 212, and/or the like for authenticating the user based on the mDL associated with the user. For example, the user authentication circuitry 210 may be configured to leverage one or more of the communications hardware 206, the mDL management circuitry 208, and/or the smart mobile wallet management circuitry 212 to authenticate the user in response to determining that the first transaction declination reason associated with the transaction attempt is comprised in the transaction declination exception set.

Accordingly, the user authentication circuitry 210 may be configured to execute an mDL authentication request associated with the user. The mDL authentication request is a request to authenticate the mDL stored in the smart mobile wallet associated with the user. In some embodiments, the mDL authentication request may be initiated, triggered, and/or executed based determining that the first transaction declination reason associated with the transaction attempt is comprised in the transaction declination exception set. In some embodiments, the user authentication circuitry 210 may be configured to facilitate the execution of the mDL authentication request based on or more data features associated with the mDL authentication request. For example, in some embodiments, the mDL authentication request may comprise one or more of user identification data (e.g., cryptographic information associated with an mDL and/or a user device) associated with the user, desired credential data associated with the mDL (e.g., a particular request may indicate a need for verification of particular user information or PII of the user, particular credential validity data, and/or the like), and/or user attribute data associated with the user.

In some examples, the mDL management circuitry 208 may be configured to generate a digital token based in part on the mDL authentication request. For example, the mDL management circuitry 208 may be configured to generate a digital token comprising cryptographic information (e.g., public key information) associated with the mDL of the user. Additionally, in some examples, the cryptographic information associated with the mDL and comprised in the digital token may be user device identification data by which a user device (e.g., user device 108A) of the user may be uniquely identified.

Furthermore, the mDL management circuitry 208 may be configured to leverage the communications hardware 206 to transmit the digital token to an IA system (e.g., IA system 110A) associated with the IA that provisioned the mDL to the user such that the IA system (e.g., IA system 110A) may decrypt the cryptographic information comprised in the digital token. In this manner, the IA system (e.g., IA system 110A) may authenticate (e.g., verify) one or more portions of credential data associated with the mDL and/or one or more portions of user device identification data associated with the user device (e.g., user device 108A) of the user.

Furthermore, in various examples, the communications hardware 206 may receive an mDL validity response from the IA system (e.g., IA system 110A) associated with the IA that provisioned the mDL to the user. In various embodiments, the mDL validity response is generated based on the digital token associated with the user. In some examples, the mDL validity response indicates verified credential data (e.g., desired credential data) associated with the mDL indicated by the mDL authentication request. Furthermore, in some examples, the mDL validity response may also indicate verified user device identification data related to the user device associated with the user (e.g., user device 108A). In this regard, the user authentication circuitry 210 may be configured to authenticate the user based on the data comprised in the mDL validity response received from the IA system (e.g., one of IA systems 110A-110N). In this manner, the smart mobile wallet management system 102 may be configured to determine whether the user has been successfully authenticated based on the mDL validity response received based on the execution of the mDL authentication request associated with the user.

In some examples, if the user authentication circuitry 210 determines that the user has not been successfully authenticated, the user authentication circuitry 210 may be configured to generate an authentication alert. In various embodiments, the authentication alert may be an alert, notification, warning, advisory, and/or the like that indicates various data related to a failed user authentication attempt related to a user. The authentication alert may comprise data related to a user that was not successfully authenticated including, but not limited to, user contact information, user account information, credential data (e.g., mDL data), user device identification data, timestamp data associated with the user authentication attempt, location data associated with the user during a time in which the user authentication attempt was executed (e.g., as indicated by GPS data collected and/or generated by a user device), and/or enterprise data (e.g., software application instance data, payment account data, user transaction data, product and/or service data, and/or the like associated with an enterprise utilizing the smart mobile wallet management system 102).

In various examples, an authentication alert may be configured as a notification, email, text message, direct application message (e.g., via a software application instance associated with the smart mobile wallet management system 102), audio message (e.g., automated voice message), banner notification, and/or the like. The user authentication circuitry 210 may be configured to leverage the communications hardware 206 to transmit an authentication alert to one or more computing devices (e.g., one or more enterprise computing device 106A-106N, user devices 108A-108B, IA systems (110A-110N), and/or the like via a number of different communication methods over a communications network (e.g., communications network 104).

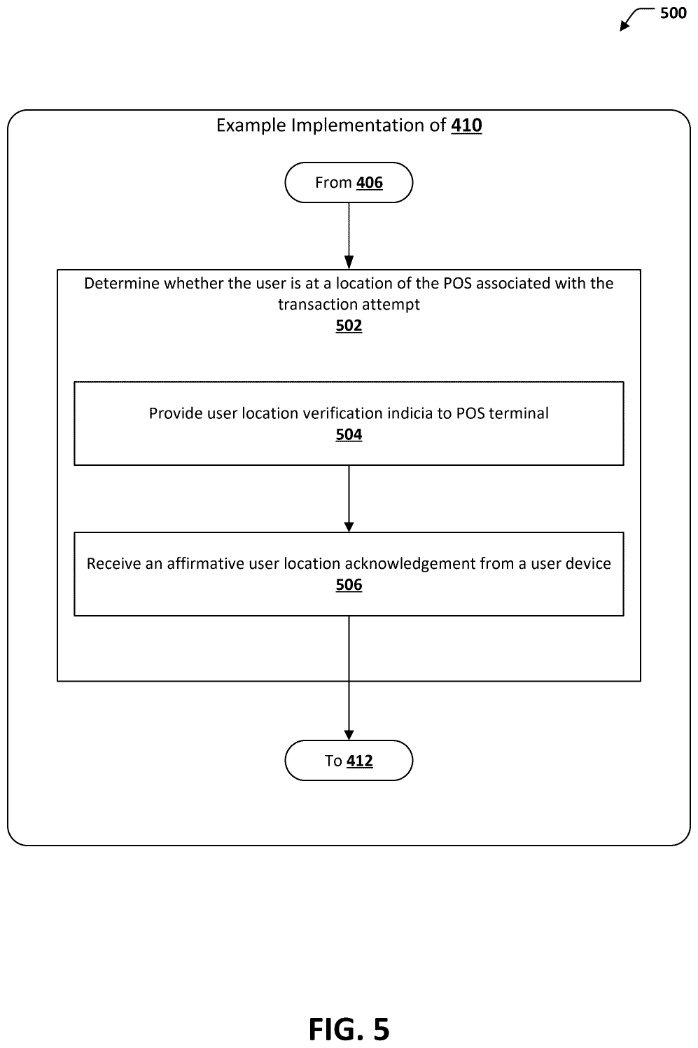

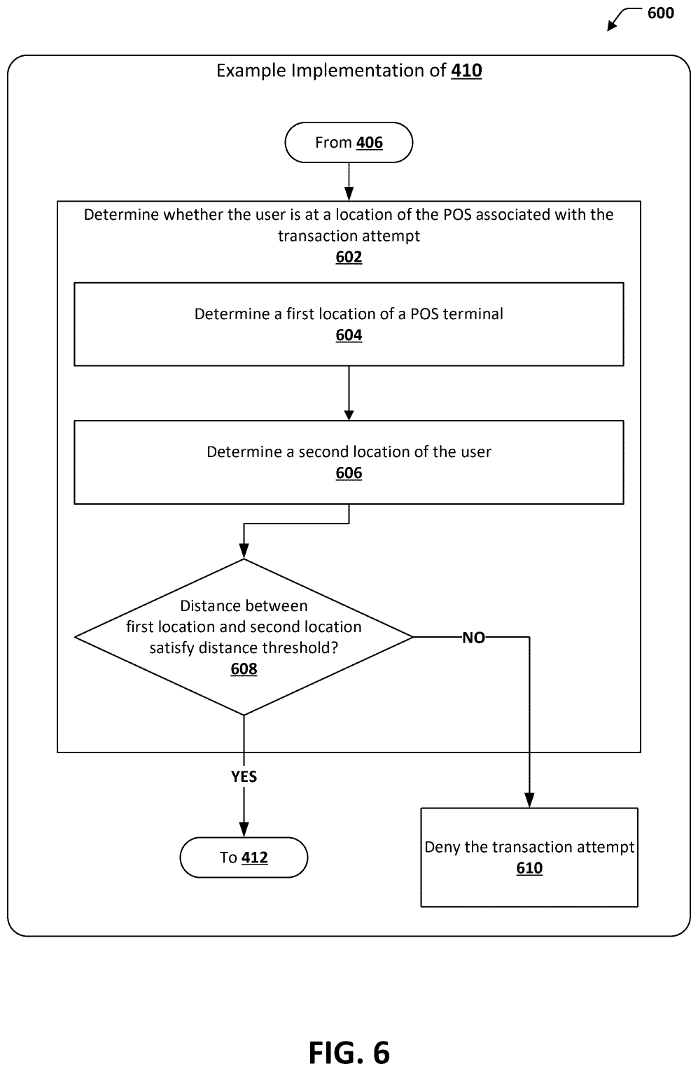

In this regard, the user authentication circuitry 210 may be configured to identify one or more individuals and/or one or more computing devices associated with said individuals to transmit the authentication alert to. For example, the user authentication circuitry 210 may be configured to identify one or more enterprise representatives associated with one or more respective enterprise computing device 106A-106N and cause transmission of an authentication alert to the one or more respective enterprise computing device 106A-106N. Additionally or alternatively, in the event that a user was not successfully identified, the user authentication circuitry 210 may be configured to cause transmission of an authentication alert to a user device (e.g., user devices 108A-108N). Further details related to the execution of operation 410 with regard to authenticating a user in order to allow a transaction attempt will be described herein below with reference to FIG. 5 and FIG. 6.

As shown by operation 412, the apparatus 200 may include means, such as processor 202, memory 204, user authentication circuitry 210, smart mobile wallet management circuitry 212, and/or the like for determining whether the user authentication was successful. For example, once the user authentication circuitry 210 has determined whether the user has been authenticated (e.g., based on the mDL validity response received in response to executing the mDL authentication request), the user authentication circuitry 210 may indicate to the smart mobile wallet management circuitry 212 whether the user has been successfully authenticated or not. As shown, in the event that the user has not been successfully authenticated, the smart mobile wallet management circuitry 212 may proceed to operation 408 in which the transaction attempt will be denied. Alternatively, if the user has been successfully authenticated, the smart mobile wallet management circuitry 212 may proceed to operation 414.

As shown by operation 414, the apparatus 200 may include means, such as processor 202, memory 204, smart mobile wallet management circuitry 212, and/or the like for allowing the transaction attempt. For example, the smart mobile wallet management circuitry 212 may be configured to allow a transaction attempt upon determining that the first transaction declination reason associated with the transaction attempt is comprised within the transaction declination exception set and that the user has been successfully authenticated (e.g., based on the mDL comprised in the smart mobile wallet associated with the user). In various examples, allowing a transaction attempt may comprise causing a transfer of an agreed-upon amount of currency equal to the transaction amount of the transaction attempt from the payment account associated with the user to a second payment account associated with a third-party merchant.

Turning now to FIG. 5, flowchart 500 illustrates example operations for determining whether a user is at a location of a POS according to various aspects described herein. As described herein, FIG. 5 illustrates some example implementations of operation 410 described herein with reference to FIG. 4. In some examples, one or more of the operations associated with the flowchart 500 are performed concurrently with one or more operations described with reference to operation 410. Alternatively, in other examples, the operations associated with the flowchart 500 may be performed in response to the execution of one or more operations described with reference to operation 410.

As shown by operation 502, the apparatus 200 may include means, such as processor 202, memory 204, smart mobile wallet management circuitry 212, and/or the like for determining whether the user at a location of the POS associated with the transaction attempt. In some examples, it may be desirable to verify that the user is at the location of the POS to provide an additional layer of security to the transaction attempt and to ensure that the intended user (e.g., the payment account owner) is the individual initiating and/or executing the transaction attempt. For example, the smart mobile wallet management system 102 may be configured to determine that the user is at a location of a POS terminal associated with the merchant involved in the transaction attempt initiated by the user.

As shown by operation 504, the apparatus 200 may include means, such as processor 202, memory 204, communications hardware 206, smart mobile wallet management circuitry 212, and/or the like for providing one or more user location verification indicia to the POS terminal associated with the transaction attempt. For example, the smart mobile wallet management circuitry 212 may be configured to generate one or more user location verification indicia and leverage the communications hardware 206 to provide the one or more user location verification indicia to the POS terminal associated with the transaction attempt.

In this regard, in various examples, the smart mobile wallet management circuitry 212 may be configured to identify a POS terminal associated with the transaction attempt and, if the POS terminal is networked (e.g., via the communications network 104) and/or configured to receive and/or display messages, the smart mobile wallet management circuitry 212 may be configured to cause display of the user location verification indicia via an electronic display of the POS terminal. Additionally, in some examples, the user location verification indicia displayed on the POS terminal may be interactive such that the user may indicate (e.g., by interacting with one or more interactive user interface elements) that they are indeed at the location of the POS terminal during the transaction attempt.

Furthermore, in some examples, the smart mobile wallet management circuitry 212 may be configured to leverage the communications hardware 206 to provide user location verification indicia via two or more methods and/or in two or more formats. For example, the smart mobile wallet management circuitry 212 may be configured to provide first user location verification indicia to the POS terminal associated with the transaction attempt and simultaneously provide second user location verification indicia to the smart mobile wallet associated with the user such that the user receives the first to the smart mobile wallet associated with the user and simultaneously provide the user location verification indicia in multiple ways and in multiple respective formats.

As described herein, the smart mobile wallet management circuitry 212 may be configured to generate unique user location verification indicia for the respective transaction attempt associated with the user. In this regard, the user location verification indicia may comprise encoded data associated with the respective transaction attempt, encoded data associated with the user (e.g., user attribute data, user payment account data), encoded data associated the merchant related to the transaction attempt, and/or the like. As such, the encoded information associated with the user location verification indicia may be utilized to confirm, verify, and/or otherwise authenticate the user associated with the respective transaction attempt.

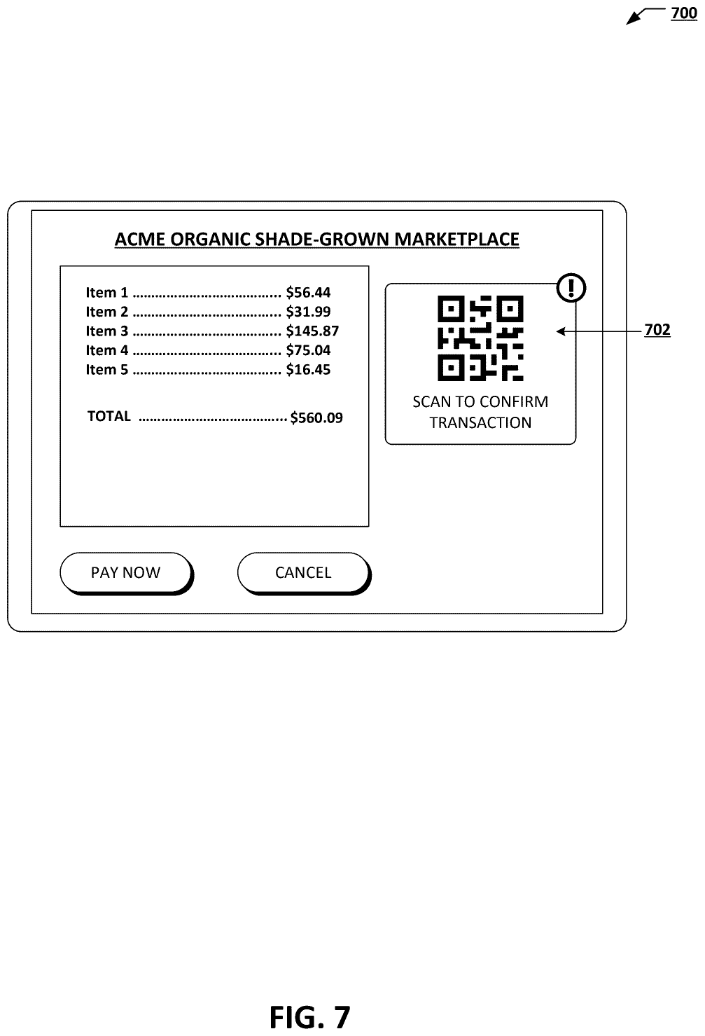

Turning briefly to FIG. 7., FIG. 7 depicts an example user interface 700 associated with a POS terminal associated with a merchant displaying a user location verification indicia 702 generated by the smart mobile wallet management system 102 during the respective transaction attempt. It will be appreciated that various configurations and/or layouts of user interfaces associated with various POS terminals may be employed by respective merchants. Accordingly, the example depicted in FIG. 7 is provided for purposes of explanation and is not intended to limit the spirit and/or the scope of the present disclosure. As shown in FIG. 7, the user location verification indicia 702 is configured as a QR code.

As described herein, in various examples, the user location verification indicia may be configured as one or more digital representations of a QR code, data matrix, Aztec code, PDF417 code, databar, codabar, barcode, and/or the like that may be scannable by an imaging device associated with a user device (e.g., user device 108A) such as a rear-facing camera of a mobile device. Additionally or alternatively, in some examples, the user location verification indicia may comprise text, images, watermarks, logos, icons, and/or the like associated with one or more of the transaction attempt, the merchant associated with the transaction attempt, and/or the enterprise associated with the smart mobile wallet management system 102. For example, the user location verification indicia 702 is configured to display the text “SCAN TO CONFIRM TRANSACTION.”

Returning now to FIG. 5, and as shown by operation 506, the apparatus 200 may include means, such as processor 202, memory 204, communications hardware 206, smart mobile wallet management circuitry 212, and/or the like for receiving an affirmative user location acknowledgement from a user device (e.g., user device 108A) associated with the user. The affirmative user location acknowledgement may confirm the user's location and/or presence during transaction attempt (e.g., the user's presence at the POS terminal). In various examples, the affirmative user location acknowledgement may be an electronically managed data structure configured to comprise various data associated with the user (e.g., user attribute data), data associated with a user device (e.g., user device identification data, location coordinate data) related to the user (e.g., user device 108A), data associated with the respective transaction attempt (e.g., location coordinate data, transaction amount, merchant identification data), data associated with the POS terminal associated with the merchant (e.g., identification data, location coordinate data, and/or the like associated with the POS terminal), and/or the like.

The affirmative user location acknowledgement may be generated in response to an interaction with the user location verification indicia (e.g., user location verification indicia 702) displayed via the electronic display of the POS terminal associated with the transaction attempt. For example, the smart mobile wallet circuitry 308 of a respective user device (e.g., user device 108A) may be configured to capture and/or scan one or more portions of image input data representative of the user location verification indicia (e.g., user location verification indicia 702) based on one or more interactions with a software application instance associated with the smart mobile wallet management system 102. In such examples, the smart mobile wallet circuitry 308 of the respective user device (e.g., user device 108A) may be configured to decode the user location verification indicia (e.g., user location verification indicia 702) in order to parse various data associated with the user location verification indicia (e.g., user location verification indicia 702). As such, the decoded data associated with the user location verification indicia (e.g., user location verification indicia 702) (e.g., decoded data associated with the respective transaction attempt, decoded data associated with the user (e.g., user attribute data, user payment account data), decoded data associated the merchant related to the transaction attempt, and/or the like) may be utilized by the smart mobile wallet circuitry 308 to facilitate the generation of an affirmative user location acknowledgement.

Additionally or alternatively, in some examples, the affirmative user location acknowledgement may be configured in a variety of other formats. For example, the affirmative user location acknowledgement may be configured as an email, a verbal confirmation (e.g., by the user to an enterprise representative), and/or a direct message (e.g., SMS message, virtual chat message, and/or the like) generated in response to second user location verification indicia (e.g., user location verification indicia 702) transmitted to the smart mobile wallet associated with the user. The smart mobile wallet management circuitry 212 may be configured to process an affirmative user location acknowledgement configured in one of the aforementioned variety of formats in order to facilitate the authentication of the user during the transaction attempt.

Additionally, as described herein, an affirmative user location acknowledgement generated in response to an interaction with the user location verification indicia (e.g., user location verification indicia 702) may comprise one or more portions of mDL data associated with the mDL of the user. As such, the affirmative user location acknowledgement may comprise one or more of cryptographic key information (e.g., public key information used to identify the mDL, a corresponding user device (e.g., user device 108A), and/or a corresponding user), originating IA data (e.g., cryptographic key information and/or identifying data associated with an originating IA), and/or other identifying data associated with the mDL of the user that is stored in the smart mobile wallet. As such, in various examples, the affirmative user location acknowledgement may be configured to comprise and/or trigger the transmission and/or execution of one or more mDL authentication requests associated with a respective user.

Turning now to FIG. 6, flowchart 600 illustrates additional example operations for determining whether a user is at a location of a POS according to various aspects described herein. As described herein, FIG. 6 illustrates some example implementations of operation 410 described herein with reference to FIG. 4. In some examples, one or more of the operations associated with the flowchart 600 are performed concurrently with one or more operations described with reference to operation 410. Alternatively, in other examples, the operations associated with the flowchart 600 may be performed in response to the execution of one or more operations described with reference to operation 410.

As shown by operation 602, the apparatus 200 may include means, such as processor 202, memory 204, communications hardware 206, smart mobile wallet management circuitry 212, and/or the like for determining whether the user at a location of the POS associated with the transaction attempt. In some examples, it may be desirable to verify that the user is at the location of the POS to provide an additional layer of security to the transaction attempt and to ensure that the intended user (e.g., the payment account owner) is the individual initiating and/or executing the transaction attempt. For example, the smart mobile wallet management system 102 may be configured to determine that the user is at a location of a POS terminal associated with the merchant involved in the transaction attempt initiated by the user.

As shown by operation 604 the apparatus 200 may include means, such as processor 202, memory 204, communications hardware 206, mDL management circuitry 208, user authentication circuitry 210, smart mobile wallet management circuitry 212, and/or the like for determining a first location of the POS terminal associated with the transaction attempt. In this regard, the smart mobile wallet management circuitry 212 may be configured to determine, receive, retrieve, and/or otherwise obtain location information associated with the POS terminal including one or more of GPS coordinates associated with the POS terminal, GPS coordinates associated with the location of the merchant that owns the POS terminal, address information associated with the location of the merchant that owns the POS terminal, and/or the like.

As such, the smart mobile wallet management circuitry may be configured to leverage the communications hardware 206 to receive or retrieve various identifying information related to the POS terminal associated with the transaction attempt. For example, the smart mobile wallet management circuitry 212 may collect identifying information associated with the POS terminal and/or one or more network devices (e.g., access points, access nodes, routers, switches, and/or the like) associated with the communications network the POS terminal is a part of. The identifying information associate with the POS terminal and/or the one or more network devices associated with the POS terminal may include machine access control (MAC) addresses, internet protocol (IP) addresses, and/or the like.

In various examples, the smart mobile wallet management circuitry 212 may use the various identifying information related to the POS terminal to obtain a precise location of the POS terminal. For example, the smart mobile wallet management circuitry 212 may utilize the various information related to the POS terminal to generate and/or cause the execution of one or more application programming interface (API) calls (e.g., executable computer program instructions) and/or Hypertext Transfer Protocol Secure (HTTPS) requests configured to obtain the GPS coordinates associated with the POS terminal and/or GPS coordinates associated with the location of the merchant that owns the POS terminal.

As shown by operation 606, the apparatus 200 may include means, such as processor 202, memory 204, communications hardware 206, smart mobile wallet management circuitry 212, and/or the like for determining a second location associated with the user. In various examples, the second location of the user may be determined by determining the location of a user device (e.g., user device 108A) associated with the user such as a smartphone, as the location of the smartphone may be ostensibly the same as the location of the user. In this regard, the smart mobile wallet management circuitry 212 may be configured to determine, receive, retrieve, and/or otherwise obtain location information associated with the user device (e.g., user device 108A) associated with the user device including one or more of GPS coordinates associated with the user device.

As such, the smart mobile wallet management circuitry may be configured to leverage the communications hardware 206 to receive or retrieve various identifying information related to the user device (e.g., user device 108A) associated with the user associated with the transaction attempt. For example, the smart mobile wallet management circuitry 212 may collect identifying information associated with the user device (e.g., user device 108A) and/or one or more network devices (e.g., access points, access nodes, routers, switches, and/or the like) associated with the communications network the user device is a part of. The identifying information associate with the user device (e.g., user device 108A) and/or the one or more network devices associated with the user device may include MAC addresses, IP addresses, and/or the like.

In various examples, the smart mobile wallet management circuitry 212 may use the various identifying information related to the user device (e.g., user device 108A) associated with the user to obtain a precise location of the user. For example, the smart mobile wallet management circuitry 212 may utilize the various information related to the user device (e.g., user device 108A) to generate and/or cause the execution of one or more API calls (e.g., executable computer program instructions) and/or HTTPS requests configured to obtain the GPS coordinates associated with the user device.

As shown by operation 608, the apparatus 200 may include means, such as processor 202, memory 204, smart mobile wallet management circuitry 212, and/or the like for determining whether the distance between the first location of POS terminal and the second location of the user satisfies a predetermined distance threshold such that it may be verified that the user is indeed at the POS terminal associated with the respective transaction attempt.

As such, the smart mobile wallet management circuitry 212 may be configured to compare a first set of GPS coordinates (e.g., latitudinal and longitudinal coordinates) associated with the POS terminal and a second set of GPS coordinates associated with the user (e.g., GPS coordinates associated with the user device (e.g., user device 108A) of the user). As a result of the comparison of the first of GPS coordinates and the second set of GPS coordinates, the smart mobile wallet management circuitry 212 may be configured to determine (e.g., calculate) a distance between the user and the POS terminal. Additionally or alternatively, the smart mobile wallet management circuitry 212 may be configured to determine a distance between the user and the location of the merchant based on GPS coordinates associated with the location of the merchant.

As described herein, the distance between the user and the POS terminal may satisfy the predetermined distance threshold if the distance between the user and the POS terminal is greater than or equal to the respective predetermined distance threshold (e.g., to within an error value of ±1%, ±5%, or any other number). In other examples, the distance between the user and the POS terminal (e.g., a numerical value or the like) may satisfy the respective predetermined distance threshold (e.g., a numerical value or the like) if the distance between the user and the POS terminal is less than or equal to the respective predetermined distance threshold (e.g., to within an error value of ±1%, ±5%, or any other number).

As such, if it is determined that the distance between the user and the POS terminal does not satisfy the predetermined distance threshold, the smart mobile wallet management circuitry 212 may proceed to operation 610. Alternatively, if it is determined that the distance between the user and the POS terminal does not satisfy the predetermined distance threshold, the smart mobile wallet management circuitry 212 may proceed to operation 412 in which it may be determined whether the user has been successfully authenticated and that the transaction attempt may be allowed to continue.

As shown by operation 610, the apparatus 200 may include means, such as processor 202, memory 204, smart mobile wallet management circuitry 212, and/or the like for denying the transaction attempt. For example, if it is determined that the distance between the user and the POS terminal does not satisfy the predetermined distance threshold, the smart mobile wallet management circuitry 212 may be configured to deny (or flag for denial) the transaction attempt such that the transaction is cancelled, and no money is withdrawn from the payment account associated with the transaction attempt. As such, the smart mobile wallet management circuitry 212 may be configured to leverage the communications hardware 206 to provide instructions and/or information to one or more computing devices associated with the merchant associated with the transaction attempt directing the merchant (or a clearinghouse, bank, or financial institution related to the merchant) to cancel, void, and/or otherwise disallow the transaction attempt.

FIGS. 4-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable automatic issue resolution at a POS. Example embodiments thus provide tools (e.g., the customizable transaction declination exception sets described herein) that overcome the problems faced by conventional payment mechanisms and techniques. By avoiding the use of conventional payment mechanisms and techniques, example embodiments thus save time and resources, while also eliminating the possibility of a transaction attempt being denied for an excusable reason. Moreover, embodiments described herein counter a wide variety of emerging risks in an evolving technological landscape.

Example embodiments also reduce the technical complexity of managing a payment account (e.g., a checking account, savings account) for a user. For example, various embodiments described herein eliminate the need for a user to log into an enterprise account (e.g., a user account associated with a financial institution) in order to override a transaction declination for a transaction attempt associated with a respective payment account. Furthermore, example embodiments described herein provided an addition layer of security for funds associated with a respective payment account by utilizing transaction confirmation methods and user location verification methods (e.g., user location verification indicia and/or affirmative user location acknowledgements) to confirm that a user is at a location of a POS during a transaction attempt.

Moreover, example embodiments contemplated herein provide technical solutions that solve real-world problems faced by users who wish to ensure the safety of various transaction and/or account management operations by employing various mDL-based user authentication techniques. While confirming the identity of an individual has been a technical challenge for years, the increasing occurrence of credit card fraud, bank account fraud, and transaction fraud (both on the web and in physical retail locations) has made this problem significantly more acute. By utilizing a legally-issued mDL to authenticate a user, embodiments of the present disclosure ensure that users are properly verified before a payment account is configured and/or the allowance for various transactions is granted, thereby increasing the security and safety of the funds associated with the payment account equipped with the transaction declination exception set described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing automatic transaction issue resolution, the method comprising:
receiving, by communications hardware, a transaction attempt at a point-of-sale (POS), wherein the transaction attempt is associated with a payment account of a user; and
determining, by smart mobile wallet management circuitry, whether the transaction attempt should be declined, wherein determining whether the transaction attempt should be declined comprises:
determining, by the smart mobile wallet management circuitry, a first transaction declination reason associated with the transaction attempt, wherein the first transaction declination reason indicates a reason that the transaction attempt should be declined,
determining, by the smart mobile wallet management circuitry, whether the first transaction declination reason is comprised in a transaction declination exception set associated with the payment account, and
in response to determining that the first transaction declination reason is comprised in the transaction declination exception set:
authenticating, by user authentication circuitry, the user based on a mobile driver's license (mDL) associated with the user; and
in response to successfully authenticating the user based on the mDL, allowing, by the smart mobile wallet management circuitry, the transaction attempt.

2. The method of claim 1, wherein authenticating the user further comprises:
determining, by the smart mobile wallet management circuitry, whether the user is at a location of the POS associated with the transaction attempt; and
in response to determining that the user is at the location of POS, authenticating, by the user authentication circuitry, the user.

3. The method of claim 2, wherein determining whether the user is at a location of the POS associated with the transaction attempt further comprises:
providing, by the communications hardware, user location verification indicia to a POS terminal associated with the POS; and
receiving, by the communications hardware, an affirmative user location acknowledgement from a user device associated with the user, wherein the affirmative user location acknowledgement is generated in response to an interaction with the user location verification indicia by the user device, and wherein the affirmative user location acknowledgement indicates that the user is at a location of the POS terminal.

4. The method of claim 3, wherein the affirmative user location acknowledgement comprises one or more portions of mDL data associated with the mDL associated with the user.

5. The method of claim 2, wherein determining whether the user is at the location of the POS associated with the transaction attempt further comprises:
determining, by the smart mobile wallet management circuitry, a first location of a POS terminal associated with the POS, wherein the first location of the POS terminal is determined based on first global positioning system (GPS) coordinates associated with the POS terminal;
determining, by the smart mobile wallet management circuitry, a second location of the user, wherein the second location of the user is determined based on second GPS coordinates associated with a user device associated with the user at a time associated with the transaction attempt;
determining, by the smart mobile wallet management circuitry, whether the first location of the POS terminal and the second location of the user satisfy a predetermined distance threshold; and
in response to determining that the first location of the POS terminal and the second location of the user satisfy the predetermined distance threshold, verifying that the user is at the location of the POS associated with the transaction attempt.

6. The method of claim 1, wherein the transaction declination exception set comprises a set of excusable transaction declination reasons, and wherein the set of excusable transaction declination reasons comprises one or more of an unresolved payment method suspension, a premature payment method closure, an incorrect transaction fraud analysis, or an invalid payment method status associated with the payment account.

7. The method of claim 1, further comprising:
providing, by the communications hardware, a transaction declination notification detailing the first transaction declination reason to one or more of a POS terminal associated with the transaction attempt, a user device associated with the user, or a smart mobile wallet associated with the user.

8. The method of claim 1, further comprising:
determining, by the smart mobile wallet management circuitry, if the payment account is linked to a smart mobile wallet associated with the user;
receiving, by the communications hardware and in response to determining that the payment account is not linked to the smart mobile wallet, payment account data associated with the payment account from a user device associated with the user; and
linking, by the smart mobile wallet management circuitry, the payment account to the smart mobile wallet such that one or more transaction attempts associated with the payment account are facilitated via the smart mobile wallet.

9. The method of claim 1, wherein authenticating the user based on the mDL further comprises:
receiving, by the communications hardware and based on a determination that the first transaction declination reason is comprised in the transaction declination exception set, an mDL authentication request, wherein the mDL authentication request is a request to authenticate the mDL associated with the user;
generating, by mDL management circuitry and based on the mDL authentication request, a digital token;
transmitting, by the communications hardware, the digital token to an issuing authority (IA) system associated with an IA that provisioned the mDL to the user;
receiving, by the communications hardware and from the IA system, an mDL validity response, wherein the mDL validity response is generated based on the digital token, and wherein the mDL validity response indicates verified credential data associated with the mDL; and
authenticating, by the user authentication circuitry, the user based on the mDL validity response.

10. The method of claim 9, wherein the mDL authentication request comprises one or more of user identification data, desired credential data associated with the mDL, or user attribute data associated with the user.

11. The method of claim 10, wherein the mDL validity response further indicates verified user device identification data related to a user device associated with the user.

12. An apparatus for providing automatic transaction issue resolution, the apparatus comprising:
communications hardware configured to:
receive a transaction attempt at a point-of-sale (POS), wherein the transaction attempt is associated with a payment account of a user;
smart mobile wallet management circuitry configured to:
determine whether the transaction attempt should be declined, wherein determining whether the transaction attempt should be declined comprises:
determining a first transaction declination reason associated with the transaction attempt, wherein the first transaction declination reason indicates a reason that the transaction attempt should be declined, and
determining whether the first transaction declination reason is comprised in a transaction declination exception set associated with the payment account; and
user authentication circuitry configured to:
in response to a determination that the first transaction declination reason is comprised in the transaction declination exception set, authenticating the user based on a mobile driver's license (mDL) associated with the user,
wherein the smart mobile wallet management circuitry is configured to allow the transaction attempt in response to a successful authentication of the user based on the mDL.

13. The apparatus of claim 12, wherein the smart mobile wallet management circuitry is further configured to:
determine whether the user is at a location of the POS associated with the transaction attempt, and
wherein the user authentication circuitry is further configured to:
in response to a determination that the user is at the location of POS, authenticate the user.

14. The apparatus of claim 13, wherein the communications hardware is further configured to:
provide user location verification indicia to a POS terminal associated with the POS; and
receive an affirmative user location acknowledgement from a user device associated with the user, wherein the affirmative user location acknowledgement is generated in response to an interaction with the user location verification indicia by the user device, and wherein the affirmative user location acknowledgement indicates that the user is at a location of the POS terminal.

15. The apparatus of claim 13, the smart mobile wallet management circuitry is further configured to:
determine a first location of a POS terminal associated with the POS, wherein the first location of the POS terminal is determined based on first global positioning system (GPS) coordinates associated with the POS terminal;
determine a second location of the user, wherein the second location of the user is determined based on second GPS coordinates associated with a user device associated with the user at a time associated with the transaction attempt;
determine whether the first location of the POS terminal and the second location of the user satisfy a predetermined distance threshold; and
in response to determining that the first location of the POS terminal and the second location of the user satisfy the predetermined distance threshold, verify that the user is at the location of the POS associated with the transaction attempt.

16. The apparatus of claim 12, wherein the transaction declination exception set comprises a set of excusable transaction declination reasons, and wherein the set of excusable transaction declination reasons comprises one or more of an unresolved payment method suspension, a premature payment method closure, an incorrect transaction fraud analysis, or an invalid payment method status associated with the payment account.

17. A computer program product for providing automatic transaction issue resolution, the computer program product comprising at least one non-transitory computer-readable storage medium storing software instructions that, when executed, cause an apparatus to:
communications hardware configured to:
receive a transaction attempt at a point-of-sale (POS), wherein the transaction attempt is associated with a payment account of a user; and
determine whether the transaction attempt should be declined, wherein determining whether the transaction attempt should be declined comprises:
determining a first transaction declination reason associated with the transaction attempt, wherein the first transaction declination reason indicates a reason that the transaction attempt should be declined,
determining whether the first transaction declination reason is comprised in a transaction declination exception set associated with the payment account, and
in response to determining that the first transaction declination reason is comprised in the transaction declination exception set:
authenticate the user based on a mobile driver's license (mDL) associated with the user; and
in response to successfully authenticating the user based on the mDL, allow the transaction attempt.

18. The computer program product of claim 17, wherein authenticating the user further causes the apparatus to:
determine whether the user is at a location of the POS associated with the transaction attempt; and
in response to a determination that the user is at the location of POS, authenticate the user.

19. The computer program product of claim 18, wherein determining whether the user is at a location of the POS associated with the transaction attempt further causes the apparatus to:
provide user location verification indicia to a POS terminal associated with the POS; and
receive an affirmative user location acknowledgement from a user device associated with the user, wherein the affirmative user location acknowledgement is generated in response to an interaction with the user location verification indicia by the user device, and wherein the affirmative user location acknowledgement indicates that the user is at a location of the POS terminal.

20. The computer program product of claim 18, wherein determining whether the user is at the location of the POS associated with the transaction attempt further causes the apparatus to:
determine a first location of a POS terminal associated with the POS, wherein the first location of the POS terminal is determined based on first global positioning system (GPS) coordinates associated with the POS terminal;
determine a second location of the user, wherein the second location of the user is determined based on second GPS coordinates associated with a user device associated with the user at a time associated with the transaction attempt;
determine whether the first location of the POS terminal and the second location of the user satisfy a predetermined distance threshold; and
in response to a determination that the first location of the POS terminal and the second location of the user satisfy the predetermined distance threshold, verify that the user is at the location of the POS associated with the transaction attempt.
